(19) United States
(12) Patent Application Publication
(10) Pub. No.: US 2026/0195690 A1
(43) Pub. Date: Jul. 9, 2026

(54) PORTFOLIO OPTIMIZATION UNDER UNCERTAINTY VIA INTEGRATED MODELING

(71) Applicant: Chevron U.S.A. Inc., San Ramon, CA (US)

(72) Inventors: Jincong HE, Sugar Land, TX (US); Changdong YANG, Sugar Land, TX (US); Yanqing WANG, Houston, TX (US); Lichi DENG, Sugar Land, TX (US); Yusuf NASIR, Houston, TX (US); Thomas Thai Binh TRAN, Mandeville, LA (US); Simon Joel MARTIN, Mandeville, LA (US); Kanwal GUPTA, Sugar Land, TX (US)

(21) Appl. No.: 19/243,627

(22) Filed: Jun. 19, 2025

Related U.S. Application Data
(60) Provisional application No. 63/742,501, filed on Jan. 7, 2025.

(51) Int. Cl. G06Q 10/0637; G06Q 10/067

(52) U.S. Cl. CPC G06Q 10/0637; G06Q 10/067

(57) ABSTRACT

A method is described for generating an integrated Markov Decision Process (MDP) model is disclosed. The method comprises generating the integrated MDP model for evaluating objective functions for the export network using the export network data, the cost data, the economics data, and a reservoir simulator capable of handling constraints in a group. Generating the integrated MDP model comprises: a) defining each prospect as a well with a corresponding decline curve in the reservoir simulator, b) defining production for each host as a well with a corresponding decline curve in the reservoir simulator, c) defining each host as a group with a corresponding capacity in the reservoir simulator, and d) defining each node of the export network as a group with a corresponding capacity in the reservoir simulator. Methods of using the integrated MDP model are also provided herein. The methods may be executed by a computer system.

### CROSS-REFERENCE TO RELATED APPLICATIONS

This application claims priority to, and the benefit of U.S. Provisional Application 63/742,501, filed on Jan. 7, 2025, the content of which is hereby incorporated by reference in its entirety.

### STATEMENT REGARDING FEDERALLY SPONSORED RESEARCH OR DEVELOPMENT

Not applicable.

### TECHNICAL FIELD

The disclosed embodiments relate generally to techniques for generating an integrated Markov Decision Process (MDP) model and usage of the integrated MDP model.

### BACKGROUND

Exploration portfolio management is a critical challenge for oil and gas companies worldwide, involving the strategic allocation of resources across numerous prospects with varying risk profiles, hydrocarbon volumes, and potential returns. This challenge exemplifies the modern portfolio theory principles in a complex industrial setting, where decision-makers must balance expected returns against various forms of risk. The capital intensive nature of deep-water exploration, combined with long project lifecycles and significant geological uncertainties, makes portfolio optimization particularly crucial for maintaining a competitive advantage.

### SUMMARY

In accordance with some embodiments, a computer-implemented method of generating an integrated Markov Decision Process (MDP) model is disclosed. The method comprises obtaining, from the non-transitory storage medium, export network data for an export network, including obtaining data for a plurality of prospects of the export network, a plurality of nodes of the export network, a plurality of hosts of the export network, and production for each host of the export network. The method comprises obtaining, from the non-transitory storage medium, cost data for the export network. The method comprises obtaining, from the non-transitory storage medium, economics data for the export network. The method comprises generating, with the physical computer processor, the integrated MDP model for evaluating objective functions for the export network using the export network data, the cost data, the economics data, and a reservoir simulator capable of handling constraints in a group. Generating the integrated MDP model comprises: a) defining each prospect as a well with a corresponding decline curve in the reservoir simulator, b) defining production for each host as a well with a corresponding decline curve in the reservoir simulator, c) defining each host as a group with a corresponding capacity in the reservoir simulator, and d) defining each node of the export network as a group with a corresponding capacity in the reservoir simulator.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates one representation of the Gulf of Mexico exploration landscape. Darker lines are the gas export pipelines; lighter lines are the oil export pipelines; Black dots are the existing platforms (hosts); Gray grids are currently leased federal blocks (potential exploration targets).

FIG. 2 illustrates the complexities in deep-water exploration portfolio planning and optimization.

FIG. 3 illustrates one embodiment of an integrated workflow for evaluating an exploration plan under given outcome.

FIG. 4 illustrates an example of adaption of the field management logic of a reservoir simulator for export network modeling.

FIG. 5 illustrates an oil production rate from two prospects tied to the same host and the base production from the host.

FIG. 6 illustrates a setup of the synthetic case study.

FIG. 7A illustrates evolution of maximum NPV across iterations; FIG. 7B illustrates evolution of maximum DPI across iterations.

FIG. 8 illustrates population objective function values and evolution of Pareto front.

FIG. 9A illustrates evolution of maximum NPV across iterations; FIG. 9B illustrates evolution of maximum DPI across iterations.

FIG. 10 illustrates population objective function values, rank 1 and 2 Pareto fronts, and corresponding expected values of NPV and DPI.

FIG. 11 illustrates a comparison of expected values of NPV and DPI between black-box optimization method (BOO) vs. Pareto fronts from proxy-accelerated optimization (PAO).

FIG. 12 illustrates the following: Left: Oil and gas production from a given platform; Right: Oil and gas production through a bottleneck in the network.

FIG. 13 illustrates one embodiment of a computer-implemented method of generating an integrated Markov Decision Process (MDP) model.

FIG. 14A illustrates one embodiment of a method referred to herein as Proxy-Accelerated Optimization (PAO).

FIG. 14B illustrates the synthetic example in the context of PAO.

FIG. 15A one embodiment of a method referred to herein as Automated Hierarchical Optimization (AHO).

FIG. 15B illustrates the synthetic example in the context of AHO.

FIG. 16 illustrates an example computing system for generating the integrated MDP model, PAO, performing one embodiment of a method referred to herein as PAO, and performing one embodiment of a method referred to herein as AHO.

Like reference numerals refer to corresponding parts throughout the drawings.

### DETAILED DESCRIPTION OF EMBODIMENTS

Exploration portfolio management is a critical challenge for oil and gas companies worldwide, involving the strategic allocation of resources across numerous prospects with varying risk profiles, hydrocarbon volumes, and potential returns. This challenge exemplifies the modern portfolio theory principles in a complex industrial setting, where decision-makers must balance expected returns against various forms of risk. The decision-making process is further complicated by the necessity to consider existing infrastructure, including producing platforms (also referred to as hosts in the context of tie-backs) with varying excess capacity available for new tie-back projects and intricate export networks (Kaiser et al., 2013). The capital intensive nature of deep-water exploration, combined with long project lifecycles and significant geological uncertainties, makes portfolio optimization particularly crucial for maintaining a competitive advantage.

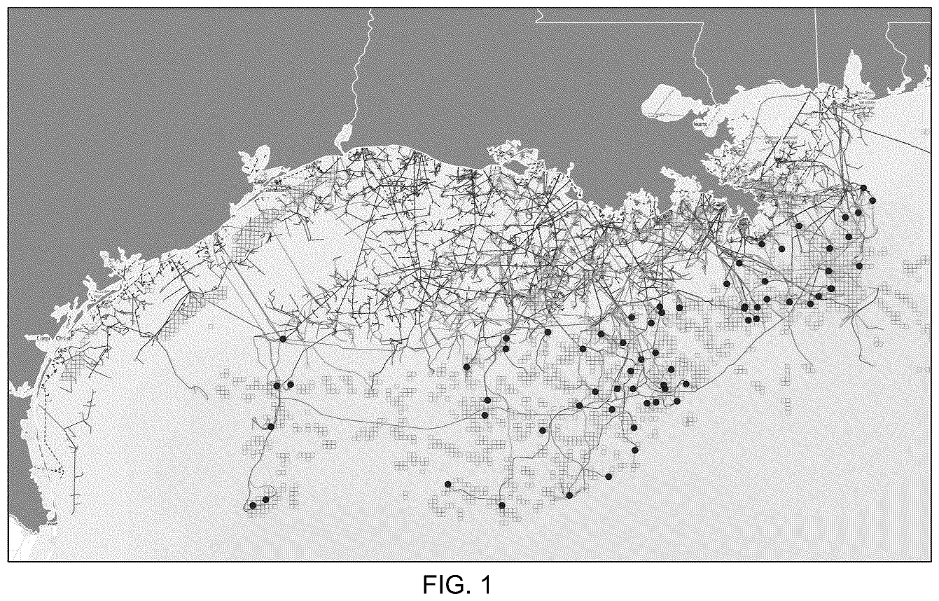

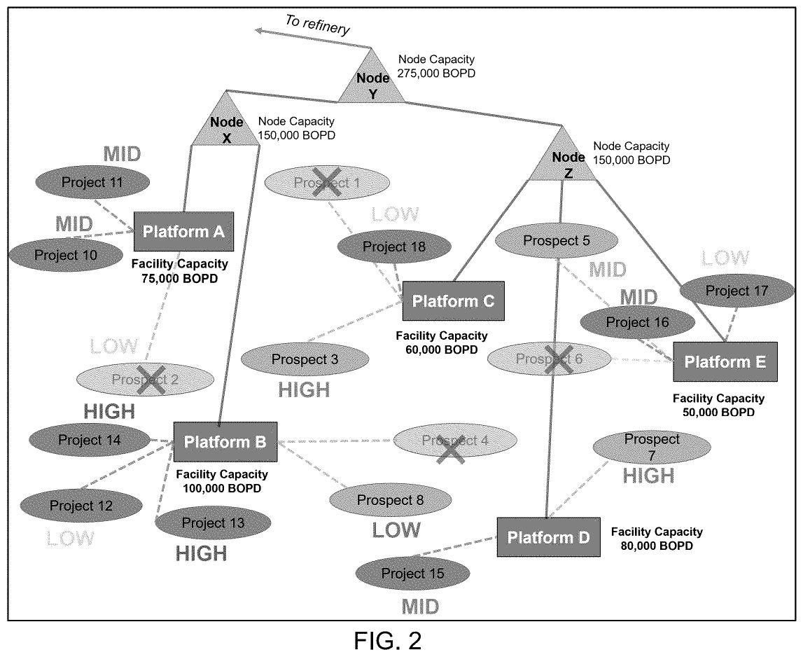

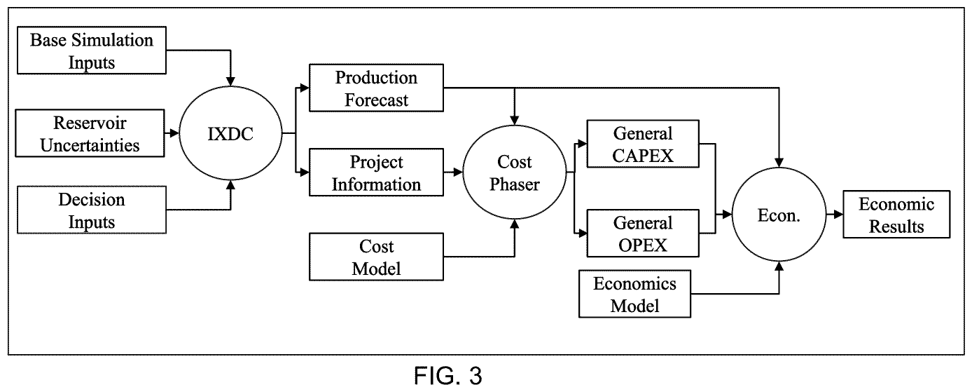

The Gulf of Mexico (GOM) exploration landscape illustrates the complexity of this challenge in deep water environments. Recent analyses indicate that deep-water developments in the GOM account for approximately 17% of total U.S. crude oil production, highlighting its strategic importance (Murawski et al., 2020). As shown in FIG. 1, the GOM contains several hundred exploration prospects and discovered resource opportunities. These prospects exhibit significant variation in their geological characteristics, resource potential, and technical risk profiles (Chakrabarti, 2018). Furthermore, the region encompasses more than 70 platforms with various levels of projected ullage/excess capacity available for tie-back projects. The exploration landscape is further complicated by an intricate oil and gas export network shared among multiple projects and operators. This shared infrastructure creates both opportunities for cost optimization and challenges in capacity allocation (Lee & Smith, 2022).

The primary objective of this research is to develop a comprehensive methodology for optimizing deep water exploration portfolios, encompassing prospect selection, tie-back host facility allocation, and project timing optimization. The development of such a methodology requires addressing multiple complexities to ensure both practical utility and analytical rigor.

The first challenge is the size of the decision space. The extensive decision space encompasses multiple dimensions of choices, including exploration sequencing, timing, tie-back facility selection within a 60-mile radius of each prospect, and working interest participation levels. This combinatorial explosion of possibilities creates a computational challenge that necessitates sophisticated optimization approaches.

Another complexity is the multifaceted constraints governing exploration and development decisions. Each prospect operates under specific lease terms with defined expiration dates that necessitate drill/no drill decisions within prescribed timeframes. Similarly, production facilities have designed operational lifespans that constrain long-term development planning. The capacity constraints present particular complexity, as each platform maintains distinct limitations for oil, gas, and water handling capabilities, with existing production streams already utilizing portions of this capacity. These capacity restrictions extend to the export network, where each segment's available ullage must be carefully managed. In addition, there are capital budget and rig availability constraints that necessitate prioritization and optimal sequencing. Traditional decision analysis models, particularly those implemented in spreadsheet environments, struggle to capture and maintain such nuanced constraints effectively.

The inherent uncertainty in exploration outcomes introduces another layer of complexity. A significant proportion of prospects typically prove unsuccessful, and even successful discoveries exhibit considerable variability in resource size. This uncertainty directly impacts facility capacity requirements and consequently, development planning. The interdependence among prospects sharing platform and export network capacities further complicates the optimization problem through what is termed the “knock-on effect”—the influence of earlier exploration outcomes on subsequent project decisions.

To illustrate this interdependence, consider a scenario involving two prospects targeting the same host platform. Traditional risked evaluations typically assume success cases for both prospects, applying the chance of success factors to production profiles and costs. However, this approach fails to capture the realistic decision dynamics. In practice, an unsuccessful initial exploration well might accelerate the timeline for subsequent prospects by freeing both budget and facility capacity. Conversely, a successful discovery might constrain or delay future developments due to capacity utilization.

LaCosta & Milkov (2022) summarized three main approaches to portfolio analysis and optimization in the petroleum industry. The first is rank and cut (RaC) (Lessard, 2003), which simply ranks investment opportunities based on characteristics like chances of success, expected monetary value, or other metrics, then selects the best prospects until the budget is exhausted. The second is the efficient frontier (EF) approach (Rubinstein, 2002), originally developed by Markowitz, which aims to develop a set of portfolio options that represent the optimal trade-off between return and risk within a mean-variance framework, with risk represented by the variance of the return. The third method is portfolio filtering (PF) (Willigers et al., 2013), which generates multiple portfolio combinations through random sampling and then filter them based on multiple decision criteria to explore the Pareto front, allowing for a more comprehensive view of portfolios that might align with different strategies.

Most of the works in the exploration portfolio study introduced above assume that the prospects are independent opportunities with given cash flows and risk profiles. They fall short when trying to address the interdependencies between prospects sharing infrastructure and the need for adaptive decision-making based on exploration outcomes. To more accurately model portfolio outcomes and fully consider these knock-on effects, this document presents a methodology for PPO that models the portfolio problem with Markov decision process (MDP) (Puterman, 2014) and reservoir simulators. This integrated approach enables comprehensive modeling of both physical and economic aspects of exploration landscapes while providing a flexible framework for optimization under uncertainty.

The methodology formulates the portfolio problem as an MDP that evolves temporally, with decisions (e.g., exploring specific prospects) at each step based on current states (e.g., current hosts and network ullage). Exploration outcomes are probabilistically determined by prospect-specific success rates, influencing subsequent state transitions. Portfolio value is evaluated through Monte Carlo simulation across multiple realizations, each processed through an integrated forward model that combines production analysis with economic evaluation.

For production modeling, this disclosure adapts the coupled-model proxy approach introduced by Yang, et al. (2022). This adaptation represents prospect production potential through decline curves while modeling hosts and export network nodes as groups. This framework enables the repurposing of reservoir simulators with surface network modeling capabilities to simulate the entire export network, forecasting production from individual prospects and pipeline nodes while maintaining oil and gas capacity constraints. This approach eliminates the need for specialized export network simulators while providing sufficient detail for sequential cost and economic analyses.

This document investigated three distinct optimization strategies for the MDP framework. The first approach, referred to as BOO herein, employs generic multi-objective evolutionary algorithms (Metaxiotis & Liagkouras, 2012) to optimize exploration sequences parameterized by prospect selection, tie-back host allocation, and ullage criteria. The second strategy, referred to as PAO herein, introduces a proxy forward model that assumes 100% exploration success to reduce computational requirements while enabling broader solution space exploration. The third approach, referred to as AHO herein, implements a multi-step heuristic process for prospect high-grading and Pareto front approximation, offering superior optimization results with reduced computational demands.

This document includes a MDP formulation, the adaptation of coupled-model proxy approaches for portfolio modeling, and the comparative analysis of multiple optimization strategies. While demonstrated through a GOM case study, the methodology's applicability extends to exploration portfolio problems across various asset classes and geographical regions.

The remainder of this document is organized as follows: First, the PPO methodology is described in detail, including the adaptation of reservoir simulators for portfolio modeling and the MDP formulation for optimization. Next, the implementation of the proposed approach is discussed with specific reference to its application in the GOM. The results of applying the proposed methodology to a synthetic but realistic exploration portfolio are then presented. Finally, the document concludes with a discussion of implications and future research directions in exploration portfolio optimization.

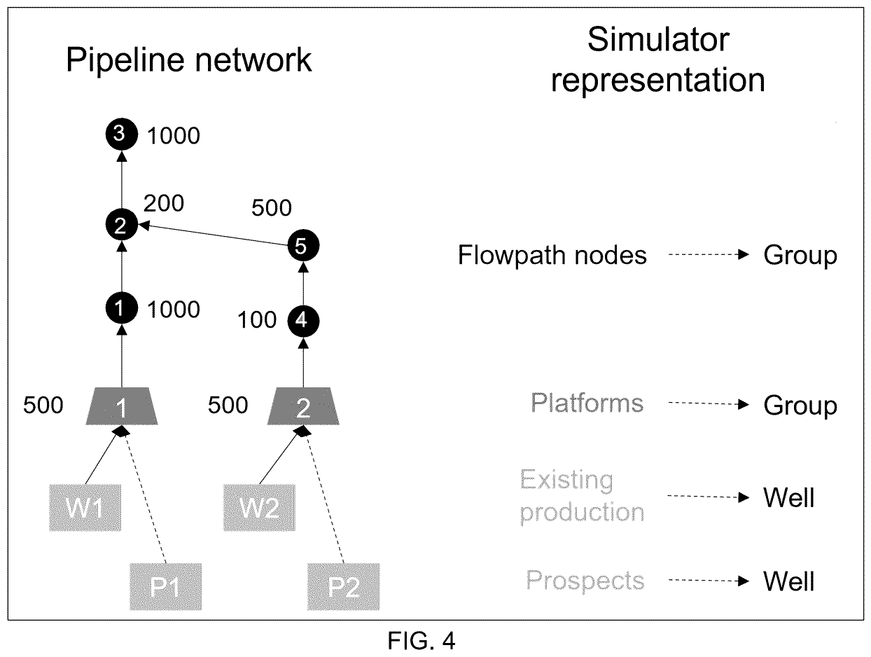

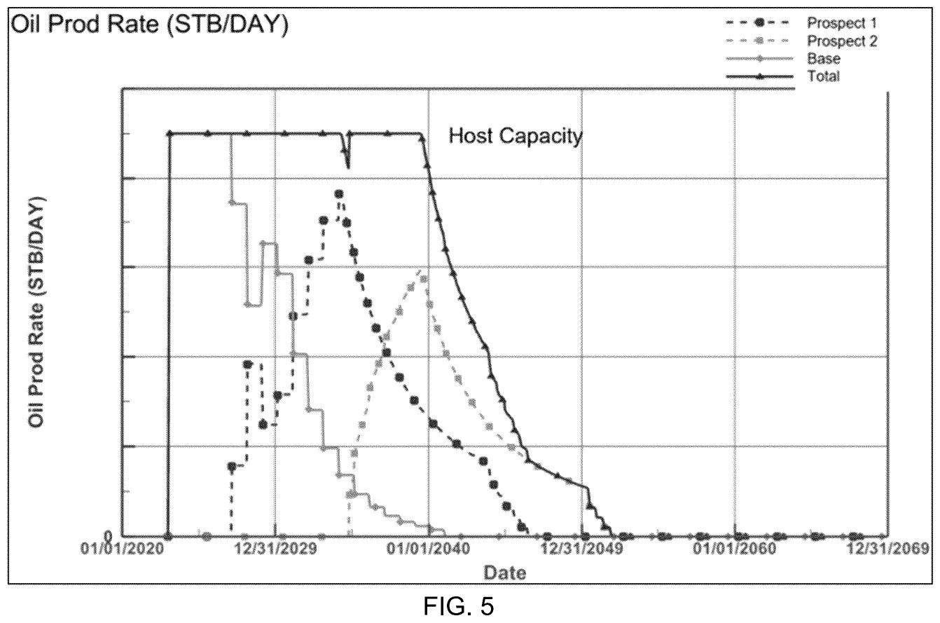

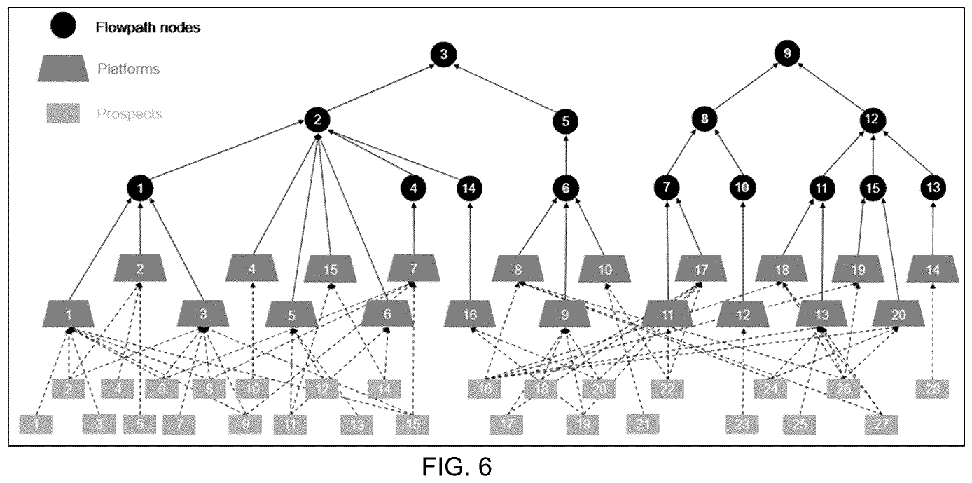

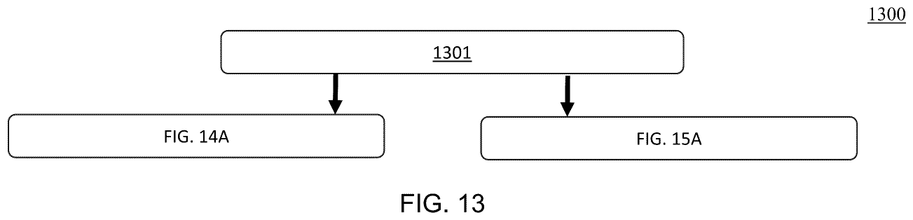

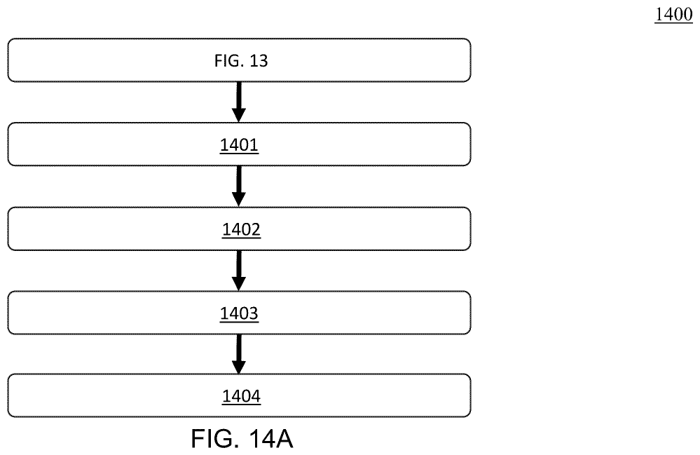

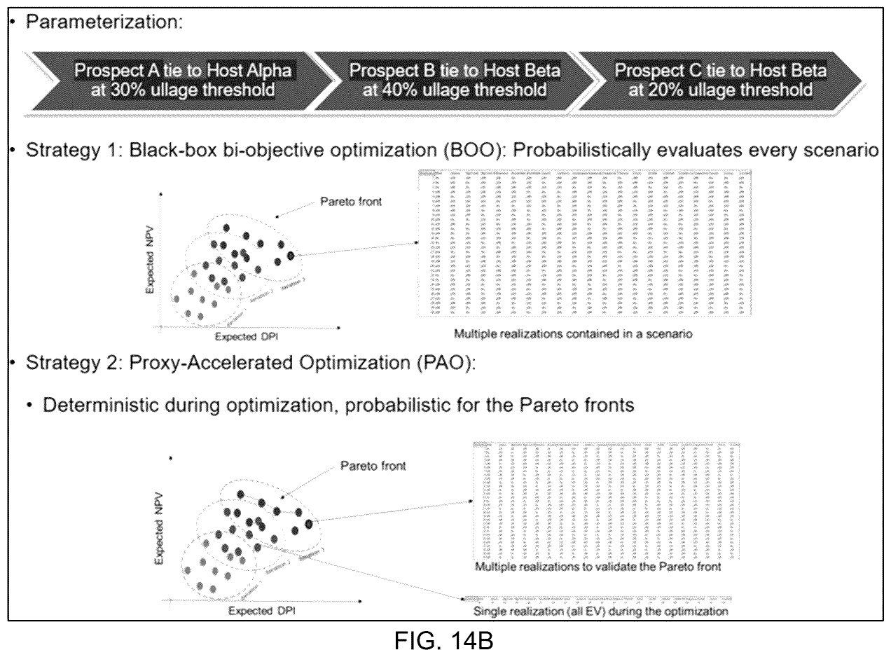

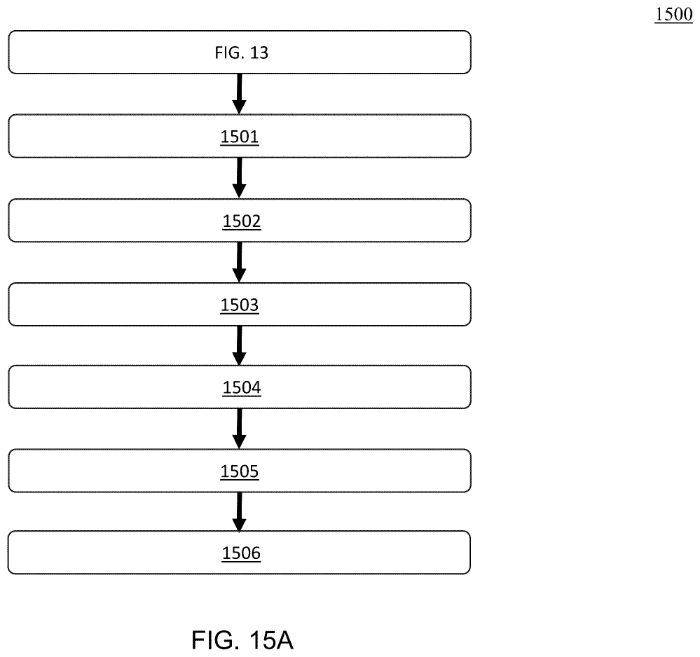

METHODOLOGY: FIG. 13 illustrates one embodiment of a computer-implemented method of generating an integrated Markov Decision Process (MDP) model, referred to as method 1300. The integrated DP model is also referred to as a forward model herein. The computer-implemented method being implemented in a computer system that comprises a physical computer processor and a non-transitory storage medium, and the method 1300 comprises a variety of steps. The method 1300 related to the integrated MDP model is discussed further in at least Table 1, FIG. 3, FIG. 4, FIG. 5, FIG. 13, and the following sections: Markov Decision Process, Integrated Modeling of Subsurface and Economics, and Network Model with Decline Curve.

At Step 1301, the method 1300 comprises obtaining, from the non-transitory storage medium, export network data for an export network, including obtaining data for a plurality of prospects of the export network (e.g., prospect production profiles), a plurality of nodes of the export network (e.g., export network topologies), a plurality of hosts of the export network (e.g., host capacity, host designed life span, outlook for host existing production profile), and production for each host of the export network.

At Step 1302, the method 1300 comprises obtaining, from the non-transitory storage medium, cost data for the export network (e.g., cost per barrel of oil for flowing through a certain segment of pipes).

At Step 1303, the method 1300 comprises obtaining, from the non-transitory storage medium, economics data for the export network.

At Step 1304, the method 1300 comprises generating, with the physical computer processor, the integrated MDP model for evaluating objective functions for the export network using the export network data, the cost data, the economics data, and a reservoir simulator capable of handling constraints in a group. Generating the integrated MDP model comprises: a) defining each prospect as a well with a corresponding decline curve in the reservoir simulator (e.g., the decline curve may be parametric, and a business unit may estimate these parameters based on geologic information), b) defining production for each host as a well with a corresponding decline curve in the reservoir simulator, c) defining each host as a group with a corresponding capacity in the reservoir simulator, and d) defining each node of the export network as a group with a corresponding capacity in the reservoir simulator.

Generating the integrated MDP model comprises using an exploration sequence defined by a list of 4-tuples: θ=[(p₁, h₁, u₁, s₁), (p₂, h₂, u₂, s₂), . . . ] where θ represents an exploration sequence, pᵢ represents a prospect, hᵢ represents its designated host, uᵢ represents a required percentage ullage threshold for exploration initiation, and sᵢ is a flag indicating whether a tie-back should be skipped.

In one embodiment, the objective functions are given policy parameters and prospect outcomes: (ENPV, EDPI)=F(θ, φ), and wherein ENPV represents an expected net present value, EDPI represents an expected discounted profitability index, F represents the integrated MDP model, θ represents an exploration sequence, and φ represents uncertainty.

Markov Decision Process: A critical aspect of accurate portfolio modeling is the incorporation of knock on effects—the influence of earlier outcomes on subsequent decisions and results. In the context of Gulf of Mexico portfolio planning and optimization (PPO), these effects primarily arise from infrastructure capacity constraints (ullage) and geological uncertainties.

To capture these complex interdependencies, the system is formulated as an MDP, defined by four fundamental components: the state space S, the action space A(S), the transition probabilities Pₐ(S, S′), and the immediate rewards Rₐ(S, S′).

In this PPO framework, the state S encompasses the projected ullage of all host facilities and pipeline infrastructure from the current time forward, along with the set of available prospects for development. The action A=π(S), defined by the policy function, maps the current state to the next action-either initiating exploration of a prospect or taking no action. The subsequent state S′ is stochastic, contingent upon exploration outcomes. A successful exploration results in the allocation of ullage capacity across corresponding host and export network infrastructure, while an unsuccessful exploration incurs costs without affecting infrastructure available capacity.

The system uncertainty, denoted by the vector, is primarily driven by prospect outcomes. The transition probability Pₐ(S, S′) effectively represents the distribution of φ, corresponding to the chance of success for each prospect. The immediate reward Rₐ(S, S′) captures the revenue or cost incurred during the current decision step.

The goal of optimization is to determine an optimal policy function π(S) that maximizes specific cumulative reward functions. This document focuses on two key objective functions: the expected net present value (ENPV) and the expected discounted profitability index (EDPI). The net present value (NPV) is the current dollar value of the forecasted cashflows (positive and negative) discounted at an appropriate rate and is defined below as Equation (1):

$$NPV = - PVI + {\sum }_{t = 1}^{T} \frac{C {F}_{t}}{{( 1 + r )}^{t}} \qquad ( 1 )$$

where:
PVI is the present value invested. If the prospect is dry, PVI is the exploration cost. If the prospect is successful, PVI also includes the field development cost
CFₜ is the net cash flow at time period t
r is the discount rate (cost of capital)
T is the total number of time periods

The expected net present value (ENPV) is defined over the distribution of computed through Monte Carlo simulation (i.e., by taking the mean of a large number of realizations). ENPV may be thought of as an average of NPV across all realizations of a given scenario, thus, an aggregated scenario NPV accounting for uncertainty in type curves. These realizations of prospect exploration outcomes are generated according to their chance of success (COS) specified by subject matter experts. An illustration of these realizations is shown in Table 1. A similar procedure is applied to calculate the expected present value invested (EPVI). EPVI is calculated over the distribution of φ computed through Monte Carlo simulation.

TABLE 1
An example illustrating how realizations are generated
and how expected values are calculated.

| | Realization | Realization | | Realization | Expected |
|---|---|---|---|---|---|
| | 1 | 2 | . . . | 50 | NPV |
| Prospect 1 | Dry | EV | . . . | EV | |
| Prospect 2 | EV | Dry | . . . | Dry | |
| Prospect 3 | Dry | EV | . . . | EV | |
| Prospect 4 | EV | EV | . . . | Dry | |
| . . . | . . . | . . . | . . . | . . . | |
| Expected | $390 MM | $590 MM | . . . | $240 MM | $400 MM |
| NPV | | | | | |

The expected discounted profitability index (EDPI) measures the capital efficiency of an investment and is related to ENPV as follows in Equation (2):

$$EDPI = 1 + \frac{ENPV}{EPVI} \qquad ( 2 )$$

With the formulation above, the goal of PPO is to optimize the policy function π(S) such that the ENPV and EDPI are maximized. The solution space for the policy function π(S) is infinite-dimensional, as it must map from a continuous state space (including ullage projections and available prospects) to a discrete action space. While classical approaches to MDP optimization, such as value iteration (Bellman, 1957) and policy iteration (Howard, 1960), or modern reinforcement learning techniques like proximal policy optimization (He et al., 2022; Nasir et al., 2021) could be applied, these methods present significant computational challenges and yield complex, non-interpretable policy functions.

Instead, this document proposes a parameterized policy approach. The exploration sequence is defined by a list of 4-tuples as in Equation (3) below:

$$θ = [ ( {p}_{1} , {h}_{1} , {u}_{1} , {s}_{1} ) , ( {p}_{2} , {h}_{2} , {u}_{2} , {s}_{2} ) , … ] \qquad ( 3 )$$

where θ represents an exploration sequence, pᵢ represents a prospect, hᵢ represents its designated host, uᵢ represents a required percentage ullage threshold for exploration initiation, and sᵢ is a flag indicating whether a tie-back should be skipped. The use of sᵢ provides the MDP a mechanism to forego exploring a certain prospect. This parameterization enables dynamic timing decisions while ensuring prospects are only explored when sufficient host facility capacity is available.

The parameterized policy function π(S, θ) is then defined algorithmically. Given the current state S at a decision step, this document goes through the exploration sequence and checks each of the elements. If the ullage outlook in hᵢ satisfies the thresholding value uᵢ, then the prospect pᵢ will be explored and the corresponding 3-tuple will be taken off the list. Depending on whether the exploration is successful, the state S (which includes host and pipeline ullage) will be updated and the MDP will move to the next decision step.

The optimization framework requires a forward model F that evaluates objective functions given policy parameters and prospect outcomes: (ENPV, EDPI)=F(θ, φ). ENPV represents an expected net present value, EDPI represents an expected discounted profitability index, F represents the integrated MDP model, θ represents an exploration sequence, and φ represents uncertainty. This document implements this through an integrated workflow detailed in subsequent sections.

Integrated Modeling of Subsurface and Economics: The forward model for Portfolio Planning and Optimization (PPO) evaluates proposed exploration sequences under specific geological outcomes through an integrated workflow, as illustrated in FIG. 3. The workflow is implemented in the FDPlan™ (SLB, 2024a) platform and its architecture includes three primary modules: production forecast, cost phaser, and economic evaluation.

The production forecast module integrates three key input components:
1. A base simulation model capturing the complete topology of the export network, such as the Gulf of Mexico export network, with base simulation inputs
2. Prospect outcomes representing reservoir uncertainty including whether the exploration is successful and how much resource is found for the prospect
3. Decision inputs/Decision variables including exploration sequence, tie-back host assignments, and first oil dates

These inputs are processed through INTERSECT™ (IX) (SLB, 2024b), a reservoir simulator adapted specifically for this application to generate production forecasts that simultaneously satisfy all capacity and timing constraints across the network. More details on the implementation of the production forecast module are provided in the next section.

The production forecasts, along with project timing information such as when to explore a certain prospect, feed into a cost phasing module that calculates and temporally distributes both capital expenditure (CAPEX) and operational expenditure (OPEX). The cost model is implemented as an explicit input to the calculation engine, providing end users with the flexibility to customize computation logic based on specific business requirements.

This modular approach extends to the economics module, where CAPEX and OPEX streams are processed through Planning Space Economics™ (Quorum Software, 2024) to generate key economic metrics including NPV and DPI. NPV is determined using equation (1) hereinabove. DPI is determined by NPV/DPI+1. The economics model is implemented as an Excel model in one embodiment.

Network Model with Decline Curves: The modeling scope encompasses hundreds of prospects potentially connecting to dozens of platforms, ultimately flowing through a complex export network to market, as illustrated in FIG. 1. While specialized software exists for surface network modeling and optimization, the approach in this document uniquely integrates subsurface behavior considerations. This document repurposes traditional reservoir simulation software, typically confined to subsurface fluid flow modeling, for this comprehensive network analysis.

Following the methodology of Yang, et al. (2022) and US Patent Application Publication No. 2023-0323772, the mature field management logic capabilities inherent in reservoir simulation software were leveraged herein. Within the INTERSECT™ decline curve (IXDC) module, the entire Gulf of Mexico export network is modeled through a system of groups and wells within the reservoir simulation framework. Each export network node is represented as a group, with connected platforms similarly modeled as groups. Existing project production on each platform is modeled as a well with a production decline curve matching its forecast profile. Prospective developments are likewise represented as wells with characteristic decline curves. This approach enables the utilization of IX's group constraint functionality to enforce oil and gas capacity limitations at both host facilities and along transport pathways.

FIG. 4 illustrates the implementation, where existing production from platforms 1 and 2 is represented by wells W1 and W2 in the simulator, each characterized by their respective decline curves. The respective decline curves for the existing production from platforms 1 and 2 represented by wells W1 and W2 in the simulator, as an input.

Similarly, prospects P1 and P2 in FIG. 4 are modeled as wells with projected decline curves. The respective projected decline curves for the prospects P1 and P2 modeled as wells in the simulator, as an input.

The platforms and flowpath nodes (numbered 1 through 5 in FIG. 4) are modeled as hierarchical groups within the simulator. The group structure follows the physical flow path: production wells and prospects are assigned to their corresponding platform groups (e.g., W1 and P1 belong to Platform 1 group), and these platform groups are then connected to downstream flowpath node groups. Each group (platforms and flowpath nodes) is assigned capacity constraints, represented by the numbers in the FIG. 4, which may specify either oil or gas production rate limitations. The assigned capacity constraints for each group (platforms and flowpath nodes) is determined by the design of the platform and flowpath. The reservoir simulator's field management logic then automatically identifies limiting constraints such as platform ullage constraint and network node constraints along the flowpath in the network and optimizes production allocation across the network while honoring all capacity restrictions such as mentioned above. The production allocation is optimized across the network while honoring all capacity restrictions by host and export network.

FIG. 5 illustrates an example of the constraint honoring a network capability. In this case, 5 prospects are tying to 2 platforms. FIG. 5 shows one of the hosts, with the diamond curve being the base production from funded projects. When the base production starts to fall off the plateau, the first prospect comes online. When production falls again, the second prospect comes online. It is clear that the platform capacity, which is the horizontal line here, is never exceeded.

### Optimization:

Synthetic Problem Setup: In addressing the portfolio optimization problem, three distinct approaches are proposed and examined using a synthetic but realistic case study involving 28 prospects and 20 eligible hosts. Tie-back operations are eligible within a 30-mile radius. FIG. 6 illustrates the spatial configuration of the system, depicting prospects (rectangles), host facilities also referred to as platforms herein (trapezoids), and nodes of the export network (circles). The topology demonstrates the complex interconnectivity of the system, where individual prospects may be eligible for tie-back to multiple hosts, while each host facility must potentially accommodate multiple prospects, creating a combinatorial optimization challenge.

Depending on the optimization strategies used, the forward model can be evaluated in two ways: deterministically and probabilistically. The deterministic evaluation assumes exploration success for all prospects and uses the expected value (EV) production profile for each prospect, resulting in a single set of economic indicators per scenario. The expected value (EV) production profile for each prospect refers to the mean of all possible production outcomes for the corresponding prospect. On the other hand, the probabilistic evaluation involves 50 realizations for each scenario. In each realization, a prospect may adopt a production profile of either EV or “Dry” (indicating no production), with the sampling determined based on the chance of success. As previously discussed, the optimization objectives are the ENPV and the EDPI for the entire portfolio. Of note, in all subsequent plots and tables in this section, the host capacities and the estimated ultimate recovery (EUR) of each prospect are normalized by the EUR of Prospect 1 under unconstrained production conditions, while all NPV and PVI numbers are normalized by the corresponding PVI of this prospect.

Black-box bi-objective optimization (BOO): Turning black-box bi-objective optimization (BOO), as previously discussed, the goal is to maximize both the economic value and efficiency of the project. The economic value is defined by the ENPV, while efficiency is defined by the expected discounted profitability index EDPI. Given two planning scenarios with the same ENPV, the scenario with the higher EDPI is preferred. Optimizing solely for ENPV tends to favor projects with a large number of prospects, disregarding efficiency. Conversely, optimizing for EDPI results in selecting a single prospect with the highest DPI. To address this conflict, a bi-objective formulation was employed that simultaneously optimizes both ENPV and EDPI.

Multi-objective optimization has gained significant traction in financial decision-making, particularly in portfolio optimization and investment analysis. Metaxiotis & Liagkouras (2012) established a comprehensive framework for applying multi-objective evolutionary algorithms to financial decision support systems. The Non-dominated Sorting Genetic Algorithm II (NSGA-II) (Deb et al., 2002) has been successfully applied to optimize financial metrics in recent years. In the context of project selection, Chen et al. (2021) demonstrated the effectiveness of NSGA-II in optimizing conflicting financial objectives, specifically focusing on NPV and profitability measures in the selection of overseas oil projects. Anagnostopoulos & Mamanis (2011) successfully applied NSGA-II to balance multiple financial indicators, including NPV and various profitability indices. This builds on the foundational work of Mansini et al. (2003), who proposed several risk measures for portfolio optimization problems.

The NSGA-II is an efficient multi-objective evolutionary algorithm that employs a fast non-dominated sorting approach and an elitist strategy. Two optimization solutions are non-dominating if neither is strictly better than the other in all optimization objectives. The algorithm maintains population diversity through a crowding distance mechanism while preserving elite solutions. For a population of size N, NSGA-II first creates an offspring population Qₜ of size N using genetic operators (crossover and mutation). The offspring (Qₜ) and parent populations (Pₜ) are combined to form Rₜ=Pₜ∪Qₜ of size 2N. The combined population Rₜ is sorted into different non-domination levels (F₁, F₂, etc.). Each solution i is assigned two attributes: (1) a non-domination rank (rᵢ) and (2) a crowding distance (dᵢ). The crowding distance dᵢ represents the perimeter of the cuboid formed using the nearest neighbors of solution i as vertices. The new parent population Pₜ₊₁ is formed by selecting solutions from the sorted fronts, prioritizing lower ranks, and, within the same rank, higher crowding distances. This process ensures both convergence toward the Pareto-optimal front and maintenance of solution diversity. This work used the implementation of NSGA-II in the Distributed Evolutionary Algorithms in Python (DEAP) library (Fortin et al., 2012). This work used a uniform mutation (with probability set as the inverse of the number of decision variables) and blended crossover for the evolutionary algorithm.

By applying this optimization approach to the synthetic case, an optimization run was conducted with 20 iterations, each comprising a population size of 30. The decision space was parameterized to focus on the sequence of the prospects, the corresponding tie-back host for each prospect, the decision of whether to explore each prospect and the starting ullage for each tie-back, which further dictates the first oil date for each field. In total, the synthetic case with 28 prospects included 112 decision variables. The initial population for the genetic algorithm was sampled randomly.

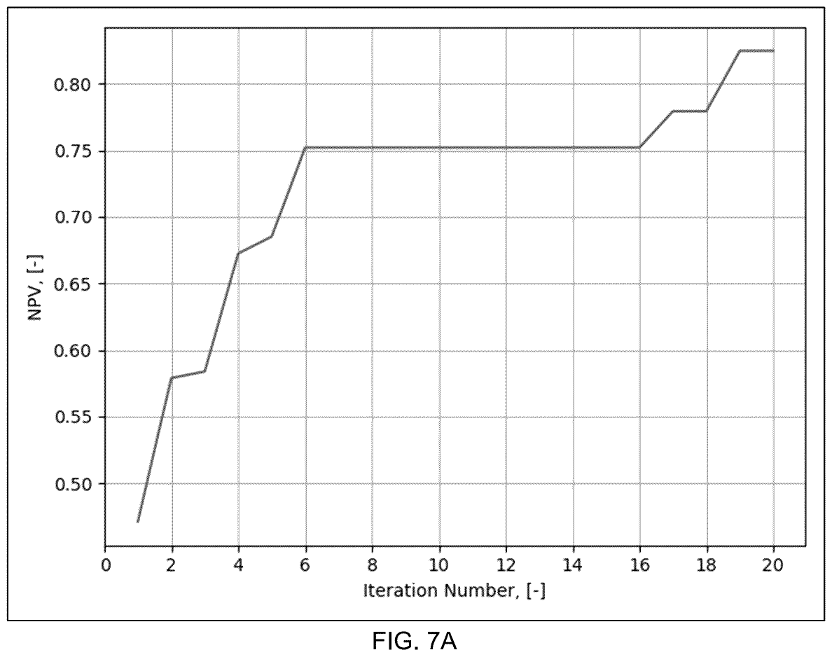

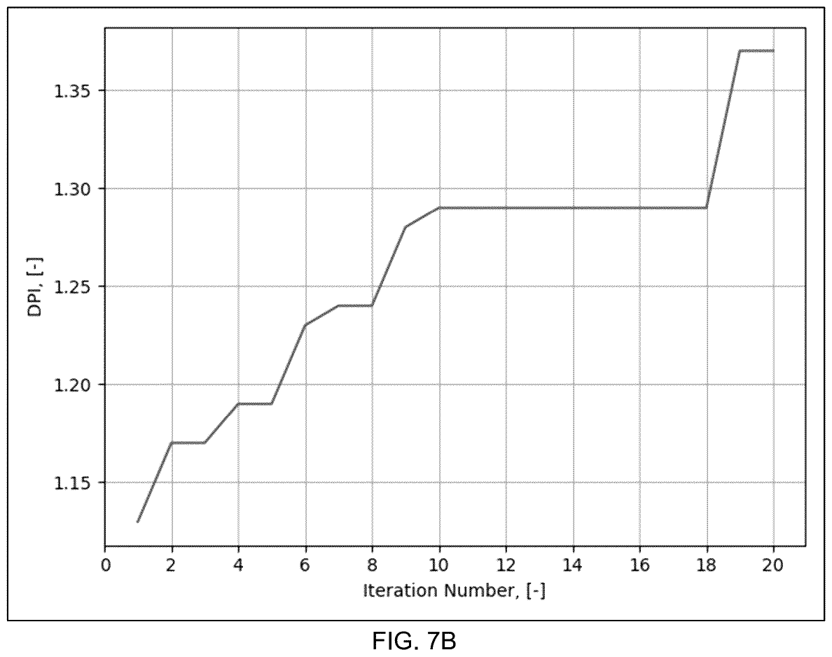

FIGS. 7A-7B illustrate the progression of the two objectives, NPV and DPI, across each iteration, both of which demonstrate a monotonic increase. When comparing the maximum values of both objectives between the first and last iterations, NPV shows a significant increase of 75 percent, while DPI exhibits an increase of approximately 21 percent.

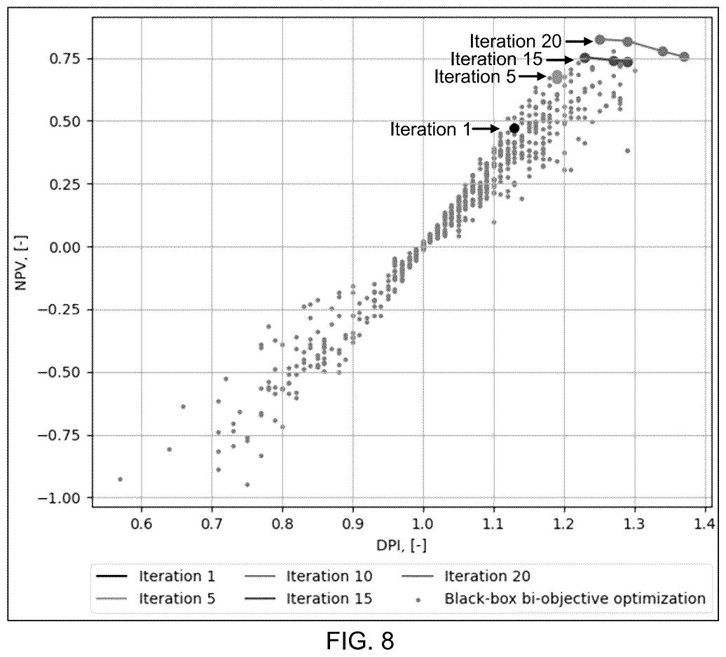

In FIG. 8, each grey dot represents the expected values of NPV and DPI from all scenarios evaluated throughout the optimization process. The color-coded lines depict the Pareto fronts generated at each iteration. It is evident that the Pareto front has progressively shifted outward with each iteration, indicating improvement. The final iterations show a Pareto front that dominates the entire population.

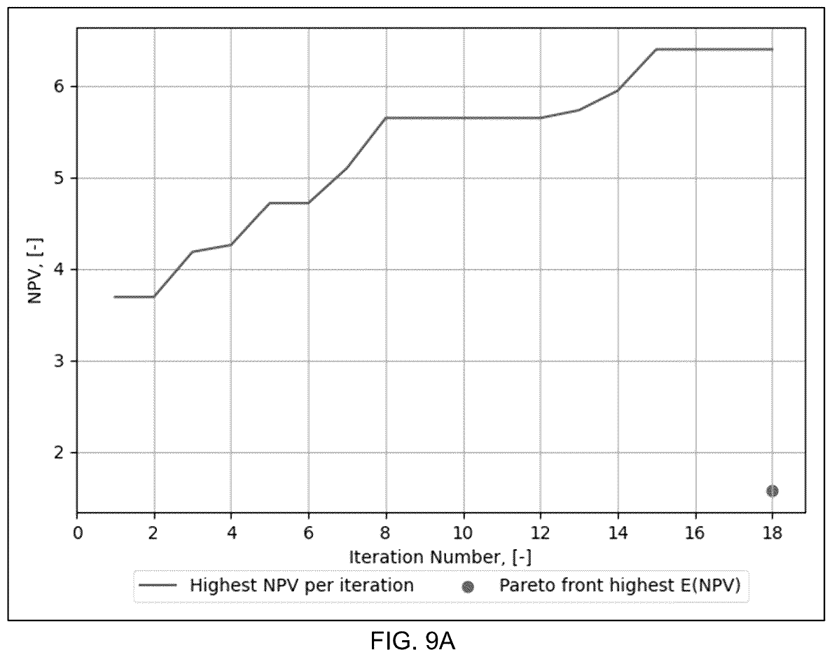

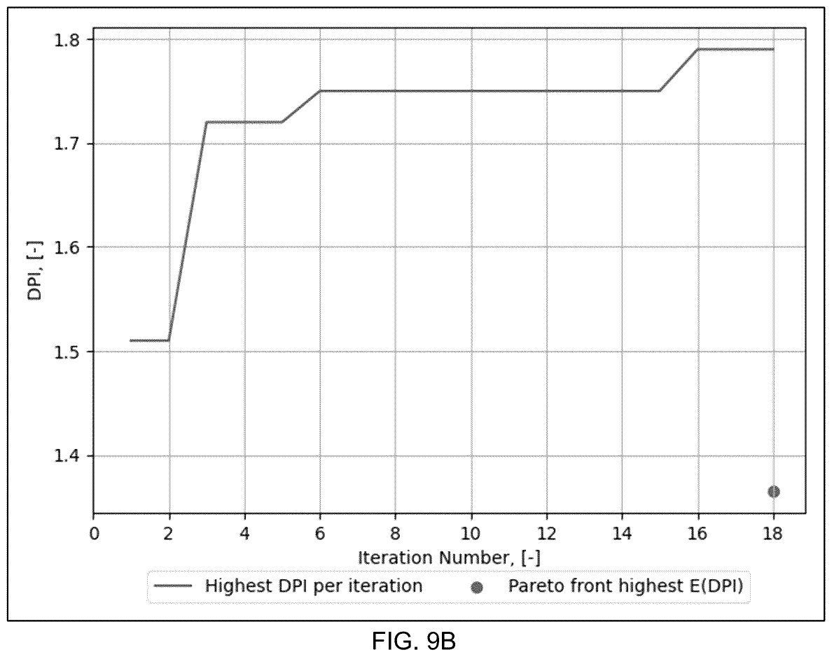

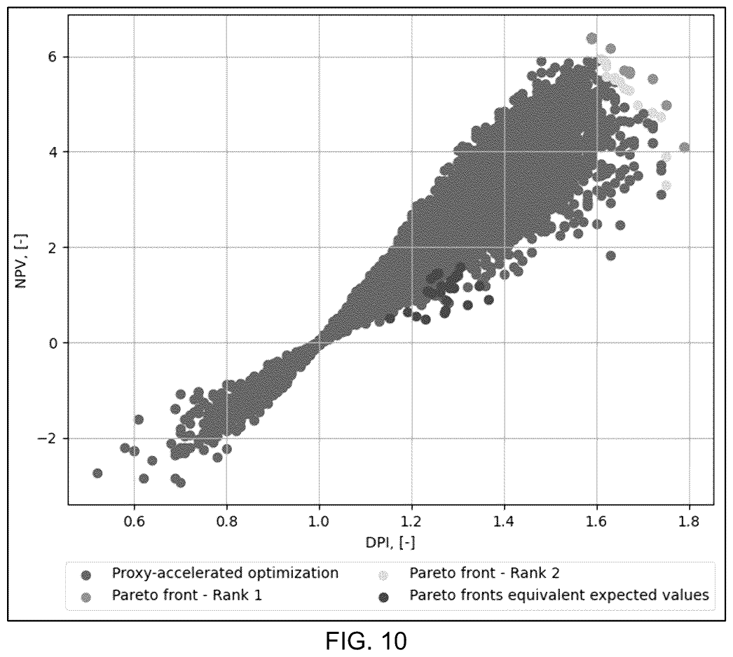

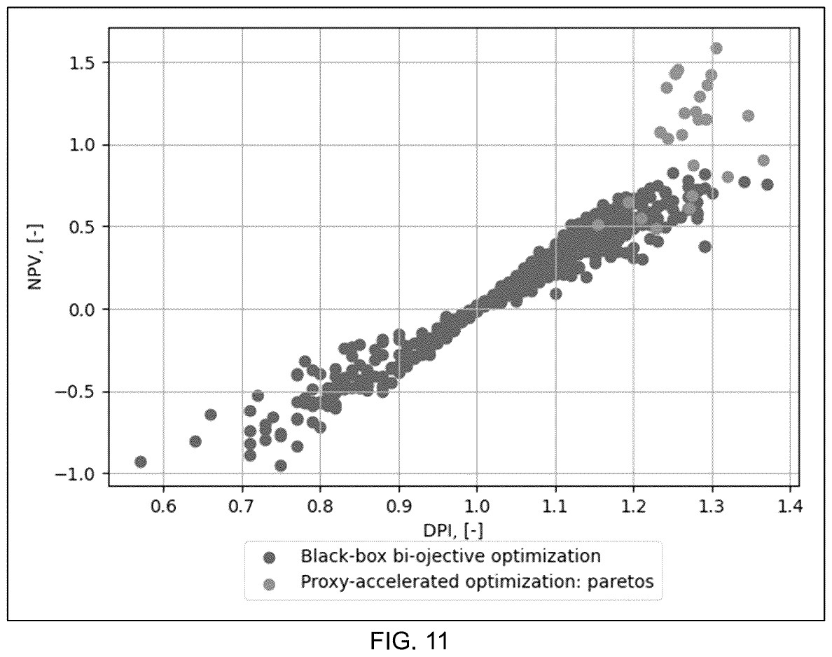

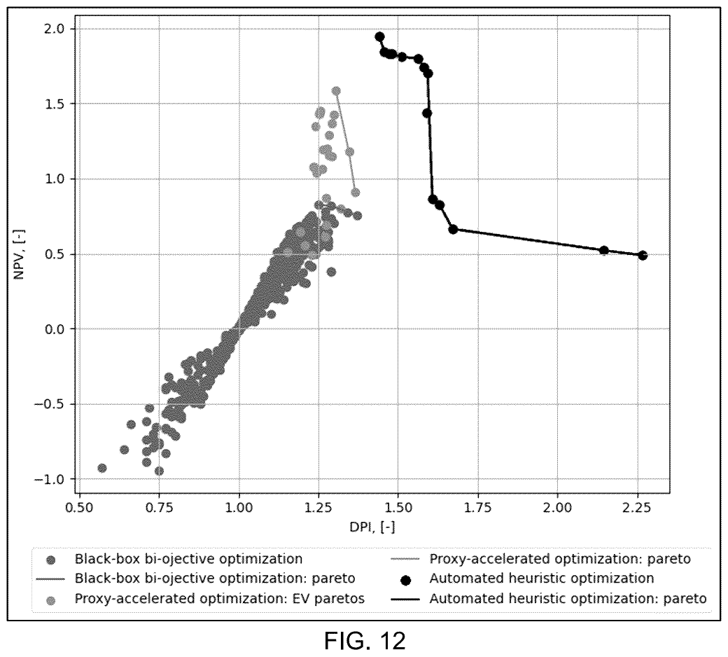

Proxy-Accelerated Optimization (PAO): Turning to proxy-accelerated optimization (PAO), the second optimization algorithm simplifies the black-box method. One drawback observed in the previous BOO algorithm is its requirement for a large number of forward simulations to identify the optimal solution. For instance, in the previous test case, although only 600 scenarios were evaluated from the vast decision space, it necessitated 30,000 forward simulations due to exploration uncertainties. To explore a wider range of the decision space more efficiently, the proxy accelerated approach was conceived. The method 1400 related to PAO is discussed further in at least FIG. 9A, FIG. 9B, FIG. 10, FIG. 11, FIG. 12, 14A, 14B, and the following section: Proxy-Accelerated Optimization (PAO).

At Step 1401, wherein the obtained export network data comprises an expected value production profile for each prospect, the method 1400 further comprises: running, with the physical computer processor, a plurality of simulation scenarios using a deterministic evaluation to generate a net present value (NPV) and a discounted profitability index (DPI) for each prospect of each simulation scenario. The deterministic evaluation considers only the expected value production profile for each prospect and assumes success for all prospects. Each simulation scenario comprises an exploration sequence (0), the expected value production profile for each prospect, and the integrated MDP model. The plurality of simulation scenarios may be constrained by honoring capacity limits for each host.

In the initial Step 1401 of this PAO approach, the genetic algorithm-based optimization is executed in a deterministic manner, considering only the expected value (EV) production profiles of the prospect and ignoring its uncertainty. The EV production profile is the average of all possible production profiles of a prospect. It is an input for the work discussed here. For example, in the first Step 1401 of PAO, the forward model (with uncertainty ignored) is run 1000s of times in the genetic algorithm. Genetic algorithm proposes different scenarios, and those scenarios are evaluated by this simplified forward model that does not consider uncertainty. This allows for a more straightforward and efficient exploration of the decision space, which significantly reduces the computational burden. For the test case presented here, 18 iterations were evaluated, each with a population size of 500. This setup allows for the exploration of 9,000 possible combinations of decision parameters during the run. FIGS. 9A-9B illustrate the increase in maximum NPV and DPI across each iteration.

At Step 1402, wherein the obtained export network data comprises a probabilistic distribution of a production profile for each prospect (e.g., probability of the prospect producing at different levels over time), the method 1400 further comprises: extracting, with the physical computer processor, rank 1 and 2 Pareto front points from the plurality of simulation scenarios. A probabilistic distribution of a production profile for each prospect may be probability of the prospect to produce at different levels over time. The Step 1402 further comprises re-evaluating, with the physical computer processor, a subset of simulation scenarios corresponding to the extracted rank 1 and 2 Pareto front points using a probabilistic evaluation to generate an ENPV and an EDPI of each simulation scenario of the subset of simulation scenarios. Each simulation scenario of the subset of simulation scenarios comprises the corresponding exploration sequence (0), the probabilistic distribution of a production profile for each prospect, uncertainty, and the integrated MDP model.

Following the deterministic optimization in Step 1401, at Step 1402, the rank 1 and 2 Pareto front points are extracted from the entire population (depicted in FIG. 10). In Step 1401, we use genetic algorithm to generate and run 1000s of runs. Those 1000s of runs are referred to as the population here. These scenarios are then re-evaluated within the probabilistic evaluation framework to generate the actual expected values of NPV and DPI for each scenario (depicted as black dots in FIG. 10). Regarding the probabilistic evaluation framework, as shown in Table 1, evaluating it probabilistically means evaluating each realization of it and taking the average.

As shown in FIG. 11, by comparing the Pareto front points' equivalent objective function values against the results from the black-box bi-objective optimization (BOO) approach, this second PAO method yielded significantly better points than most scenarios evaluated in the first BOO approach. The advantage of this PAO method lies in its more effective exploration of the large decision space, evaluating 15 times more decision parameter combinations. The outcome of running PAO is to identify a set of optimized exploration sequences that has high NPV and DPI values, as illustrated by the lighter grey dots in FIG. 11. FIG. 14B illustrates the synthetic example in the context of PAO.

At Step 1403, wherein the computer system comprises a display, and the method 1400 further comprises: generating, with the physical computer processor, a representation of the generated ENPV and the generated EDPI for each simulation scenario of the subset of simulation scenarios, each representing the corresponding exploration sequence (θ), using visual effects; and displaying the representation via the display. For PAO, each black dot in FIG. 10 may be generated and displayed (with or without the other dots in FIG. 10) at the Step 1403, such as in a diagram formal as illustrated in FIG. 10. A user may select among these black dots, and the user may provide the selection via a user interface.

At Step 1404, the method 1400 further comprises further comprises: generating, with the physical computer processor, a representation of a selected exploration sequence using visual effects; and displaying the representation via the display. The selected exploration sequence (e.g., selected by a user at the Step 1403) may be generated and displayed via the display at the Step 1404 in a diagram format, in a table format (e.g., includes the first column of Table 5), etc.

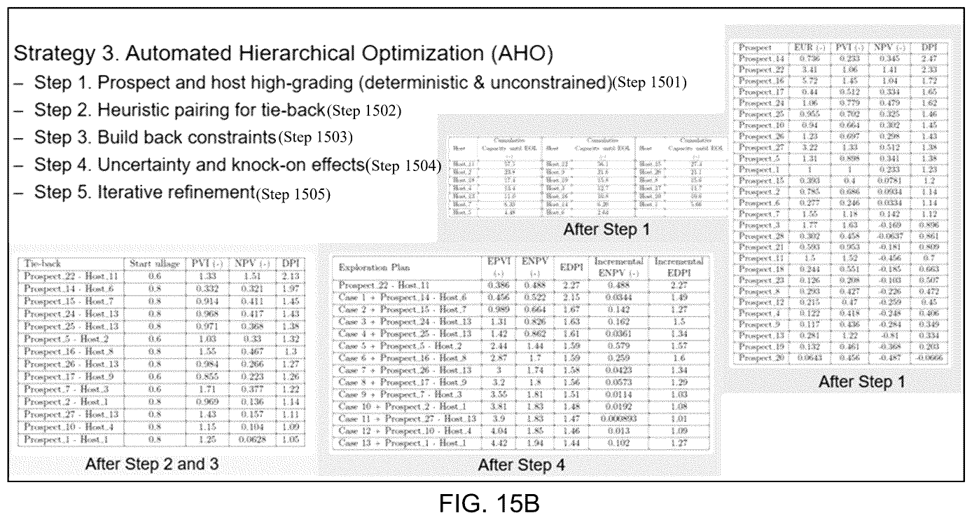

Automated Hierarchical Optimization (AHO): The black-box approaches require a significant number of runs to explore the space sufficiently due to the complexity of constraints, knock-on effects, and uncertain exploration outcomes. In order to reduce the number of runs, the method 1500 introduces an automated hierarchical optimization (AHO) approach in which constraints, uncertainty, and knock-on effects are first ignored and prospects and their preferred tie-back hosts are pre-screened. The complexity is then gradually built back. Finally, the high-graded list of projects is sorted to construct a minimum functional objective (MFO) staircase, which can be viewed as an empirical Pareto front. The method 1500 related to AHO is discussed further in at least Table 2, Table 3, Table 4, Table 5, FIG. 12, FIG. 15A, FIG. 15B, and the following sections: Automated Hierarchical Optimization (AHO), Prospect and Host High-Grading, Heuristic Pairing for Tie-Back, Build Back Constraints, Uncertainty and Knock-On Effects, and Iterative Refinement.

Prospect and Host High-Grading: At Step 1501, wherein the obtained export network data comprises an expected value production profile for each prospect, the method 1500 further comprises: running, with the physical computer processor, a first single unconstrained simulation scenario using an exploration sequence (θ), the expected value production profile for each prospect, and the integrated MDP model with a deterministic evaluation to generate a NPV and a DPI for each prospect. The deterministic evaluation assumes unlimited ullage for each host, unlimited ullage for each node of the export network, all prospects finds exploration success with production profile the same as the EV production profile, and each prospect ties back to a nearest host assuming unlimited ullage. The nearest host may be determined by geometrical distance, for example, using longitude and latitude. Running the first single unconstrained simulation scenario generates a ranked list of prospects that ranks each prospect by its corresponding DPI. Running the first single unconstrained simulation scenario generates a ranked list of hosts that ranks each host by its corresponding ullage.

At Step 1501, prospect exploration is assumed to be always successful so no probabilistic evaluation is needed. All hosts and export network nodes are assumed to have unlimited capacity, so production from different prospects would not need to compete for ullage. All prospects are assumed to tie back to the nearest (sometimes referred to as closest herein) hosts. The economic metric of the prospect under this setting is calculated and ranked by DPI. Prospects with negative NPV or DPI smaller than 1 will be excluded from further consideration. The main goal of Step 1501 is to high-grade promising prospects and eliminate the ones that are not economical even in an unconstrained setting. Table. 2 shows the result of Step 1501 applied to the synthetic case. It can be seen that 13 out of the 28 prospects are eliminated due to unfavorable economics.

In one embodiment, the economic metric includes EUR. In one embodiment, the economic metric includes PVI. In one embodiment, the economic metric includes NPV. In one embodiment, the economic metric includes DPI. In one embodiment, the economic metric includes EUR, PVI, NPV, DPI, or any combination thereof. The economic metric of the prospect under this setting is calculated and ranked by DPI. EUR values may be determined by integrating the actual production profile over time. PVI may be determined by discounting all capital investment to present time. NPV may be determined by discounting all future cash flow to present time. DPI may be determined by 1+NPV/PVI. EUR, PVI, NPV, DPI, or any combination thereof may be from the data obtained in the method 1300. The economic metrics of the prospects include NPV, DPI, EUR, and/or PVI. The calculation of NPV, DPI and PVI are given herein. EUR is the total oil/hydrocarbon that can be forecasted to produce from a prospect.

In one embodiment, generating the ranked list of prospects comprises removing any prospect having a corresponding NPV that is negative from the ranked list of prospects. Prospects with negative NPV will be excluded from further consideration.

In one embodiment, generating the ranked list of prospects comprises: comparing each DPI of a prospect to a first threshold; and based on the comparison, removing any prospect with a corresponding DPI that does not satisfy the first threshold from the ranked list of prospects. Prospects with DPI smaller than a first threshold, such as smaller than 1, will be excluded from further consideration. Alternatively, prospects with DPI equal to or more than 1 may be kept for further consideration. The first threshold may be provided by a user. The first threshold may be customizable based on what is competitive for that prospect(s). The minimum for the first threshold may be 1, as a prospect may not be profitable below 1, but a business entity may ultimately decide.

The main goal of Step 1501 is to high-grade promising prospects and eliminate the ones that are not economical even in an unconstrained setting. Table 2 shows the result of Step 1501 applied to the synthetic case. It can be seen that 13 out of the 28 prospects are eliminated due to unfavorable economics for the synthetic case, as those 13 prospects had negative NPV values. Table 2 illustrates generating a ranked list of prospects that ranks each prospect by its corresponding DPI.

TABLE 2
Prospect economics analysis. In this and subsequent tables,
(—) indicates the quantity is normalized and dimensionless.

| Prospect | EUR (—) | PVI (—) | NPV (—) | DPI |
|---|---|---|---|---|
| Prospect_14 | 0.736 | 0.233 | 0.345 | 2.47 |
| Prospect_22 | 3.41 | 1.06 | 1.41 | 2.33 |
| Prospect_16 | 5.72 | 1.45 | 1.04 | 1.72 |
| Prospect_17 | 0.44 | 0.512 | 0.334 | 1.65 |
| Prospect_24 | 1.06 | 0.779 | 0.479 | 1.62 |
| Prospect_25 | 0.955 | 0.702 | 0.325 | 1.46 |
| Prospect_10 | 0.94 | 0.664 | 0.302 | 1.45 |
| Prospect_26 | 1.23 | 0.697 | 0.298 | 1.43 |
| Prospect_27 | 3.22 | 1.33 | 0.512 | 1.38 |
| Prospect_5 | 1.31 | 0.898 | 0.341 | 1.38 |
| Prospect_1 | 1 | 1 | 0.233 | 1.23 |
| Prospect_15 | 0.393 | 0.4 | 0.0781 | 1.2 |
| Prospect_2 | 0.785 | 0.686 | 0.0934 | 1.14 |
| Prospect_6 | 0.277 | 0.246 | 0.0334 | 1.14 |
| Prospect_7 | 1.55 | 1.18 | 0.142 | 1.12 |
| Prospect_3 | 1.77 | 1.63 | −0.169 | 0.896 |
| Prospect_28 | 0.302 | 0.458 | −0.0637 | 0.861 |
| Prospect_21 | 0.593 | 0.953 | −0.181 | 0.809 |
| Prospect_11 | 1.5 | 1.52 | −0.456 | 0.7 |
| Prospect_18 | 0.244 | 0.551 | −0.185 | 0.663 |
| Prospect_23 | 0.126 | 0.208 | −0.103 | 0.507 |
| Prospect_8 | 0.293 | 0.427 | −0.226 | 0.472 |
| Prospect_12 | 0.215 | 0.47 | −0.259 | 0.45 |
| Prospect_4 | 0.122 | 0.418 | −0.248 | 0.406 |
| Prospect_9 | 0.117 | 0.436 | −0.284 | 0.349 |
| Prospect_13 | 0.281 | 1.22 | −0.81 | 0.334 |
| Prospect_19 | 0.132 | 0.461 | −0.368 | 0.203 |
| Prospect_20 | 0.0643 | 0.456 | −0.487 | −0.0666 |

Step 1501 only requires running the forward model (i.e., the integrated MDP model) once. From this run, a preliminary estimate of the cumulative projected ullage for each host may be obtained, which is calculated as the cumulative capacity (nameplate capacity*time till its end of life) and the cumulative production till its end of life. Nameplate capacity refers to the designated capacity of the host. Time till its end of life may be the designated life span. EOL may be thought of as the rest of an existing host's designed life span, and it can be anywhere from 0 to 50 years. Capacity and end of life may come from the design of the host. In some embodiments, end of life may be at least 20 years (e.g., at least 21 years, at least 22 years, at least 23 years, at least 24 years, at least 25 years, at least 26 years, at least 27 years, at least 28 years, at least 29 years, at least 30 years, at least 35 years, at least 40 years, or at least 45 years). In one embodiment, end of life may be 20-30 years. In one embodiment, end of life may be 20-50 years. In one embodiment, end of life may be 0-50 years. Cumulative production till its end of life may be determined by the forward model of the method 1300. Table 3 listed cumulative ullage from each host for the synthetic case. Table 3 illustrates generating a ranked list of hosts that ranks each host by its corresponding ullage.

TABLE 3
Host cumulative ullage analysis.

| | Cumulative | | Cumulative | | Cumulative |
|---|---|---|---|---|---|
| | Capacity | | Capacity | | Capacity |
| Host | until EOL (—) | Host | until EOL (—) | Host | until EOL (—) |
| Host_11 | 57.5 | Host_12 | 56.1 | Host_15 | 27.4 |
| Host_2 | 23.8 | Host_9 | 21.6 | Host_20 | 21.1 |
| Host_18 | 17.4 | Host_19 | 15.8 | Host_8 | 15.6 |
| Host_4 | 13.4 | Host_3 | 12.7 | Host_17 | 11.7 |
| Host_13 | 11.0 | Host_16 | 10.8 | Host_10 | 10.6 |
| Host_7 | 6.33 | Host_14 | 6.20 | Host_1 | 5.66 |
| Host_5 | 4.48 | Host_6 | 2.64 | | |

Heuristic Pairing for Tie-Back: At Step 1502, the method 1500 further comprises: running, with the physical computer processor, a second single unconstrained simulation scenario using an exploration sequence (θ), the expected value production profile for each prospect, and the integrated MDP model with a deterministic evaluation to generate a NPV and a DPI for each prospect. The deterministic evaluation assumes unlimited ullage for each host, unlimited ullage for each node of the export network, success for all prospects, and each prospect ties back to a nearest host with sufficient ullage based on a second threshold. Running the second single unconstrained simulation scenario generates a first ranked list of prospect and host tie-backs that is ranked by corresponding DPI. The nearest host may be determined by geometrical distance, for example, using longitude and latitude

In Step 1501, the prospects are tied to the nearest host assuming unlimited ullage. The nearest hosts may not have enough ullage to accommodate these prospects. In Step 1502, each prospect from Step 1501 is now tied to the nearest host whose cumulative ullage satisfies a second threshold, such as accommodate at least a particular percentage (e.g., at least 90%, at least 91%, at least 92%, at least 93%, at least 94%, at least 95%, at least 96%, at least 97%, at least 98%, at least 99%, 90%-95%, 90%-100%, etc.) of the prospect's EUR (or other value) within a particular number of years (e.g., within 10 years, within 15 years, within 20 years, within 25 years, with 30 years, within 40 years, within 50 years, 10-50 years, 15-50 years, 20-50 years, etc.). Thus, the second threshold may include multiple requirements. The particular number of years may depend on the time till a host's end of life.

In one embodiment, in Step 1502, each prospect from Step 1501 is now tied to the nearest host whose cumulative ullage can accommodate 90% of the prospect's EUR within 20 years, and the second threshold is 90% of the prospect's EUR within 20 years in this embodiment. In one embodiment, in Step 1502, each prospect from Step 1501 is now tied to the nearest host whose cumulative ullage can accommodate a second threshold of at least 90% of the prospect's EUR within 20 years (e.g., at least 91% of the prospect's EUR within 20 years, at least 92% of the prospect's EUR within 20 years, at least 93% of the prospect's EUR within 20 years, at least 94% of the prospect's EUR within 20 years, at least 95% of the prospect's EUR within 20 years, at least 96% of the prospect's EUR within 20 years, at least 97% of the prospect's EUR within 20 years, at least 98% of the prospect's EUR within 20 years, or at least 99% of the prospect's EUR within 20 years).

In Step 1502, the evaluation is still deterministic and unconstrained. The difference from Step 1501 is that now there is a more realistic estimate of the tie-back cost.

Build Back Constraints: At Step 1503, the method 1500 further comprises running, with the physical computer processor, a constrained simulation scenario for each prospect and host tie-back from the ranked list of prospect and host tie-backs using an exploration sequence (θ) that includes only that prospect and host tie-back, the expected value production profile of that prospect, and the integrated MDP model with a deterministic evaluation to generate a NPV and a DPI for that prospect and host tie-back. Running the constrained simulation scenario for each prospect and host tie-back generates a second ranked list of prospect and host tie-backs that is ranked by corresponding DPI. A constrained simulations scenario for each prospect is run in Step 1503 to account for sufficient ullage from the Step 1502.

Step 1503 evaluates the list of projects in Table 4 individually assuming all of them are successful exploration but taking into account host and export network ullage constraints. This Step 1503 is designed to rule out projects with uneconomical tie-backs due to host/pipeline capacity limits.

In addition, different start-time options are also considered by running the scenario under various ullage thresholds (e.g., 40%, 60%, and 80% ullage thresholds). These ullage thresholds in the Step 1503 are also referred to as third threshold or third thresholds herein. The optimal ullage threshold determined in this step will be carried over to the next steps.

After Step 1503 is completed, all remaining projects are ranked by their estimated DPI (i.e., EDPI). Note that this DPI still does not consider the chance of success and the knock-on effects.

For the synthetic case, Step 1503 includes evaluating the list of projects in Table 4 individually assuming all of them are successful exploration but taking into account host and export network ullage constraints. In addition, different start-time options are also considered by running the scenario under 40%, 60%, and 80% ullage thresholds.

TABLE 4
List of projects after Step 1503.

| Tie-back | Start ullage | PVI (—) | NPV (—) | DPI |
|---|---|---|---|---|
| Prospect_22 - Host_11 | 0.6 | 1.33 | 1.51 | 2.13 |
| Prospect_14 - Host_6 | 0.8 | 0.332 | 0.321 | 1.97 |
| Prospect_15 - Host_7 | 0.8 | 0.914 | 0.411 | 1.45 |
| Prospect_24 - Host_13 | 0.8 | 0.968 | 0.417 | 1.43 |
| Prospect_25 - Host_13 | 0.8 | 0.971 | 0.368 | 1.38 |
| Prospect_5 - Host_2 | 0.6 | 1.03 | 0.33 | 1.32 |
| Prospect_16 - Host_8 | 0.8 | 1.55 | 0.467 | 1.3 |
| Prospect_26 - Host_13 | 0.8 | 0.984 | 0.266 | 1.27 |
| Prospect_17 - Host_9 | 0.6 | 0.855 | 0.223 | 1.26 |
| Prospect_7 - Host_3 | 0.6 | 1.71 | 0.377 | 1.22 |
| Prospect_2 - Host_1 | 0.8 | 0.969 | 0.136 | 1.14 |
| Prospect_27 - Host_13 | 0.8 | 1.43 | 0.157 | 1.11 |
| Prospect_10 - Host_4 | 0.8 | 1.15 | 0.104 | 1.09 |
| Prospect_1 - Host_1 | 0.8 | 1.25 | 0.0628 | 1.05 |

Uncertainty and Knock-On Effects: At Step 1504, the method 1500 further comprises generating, with the physical computer processor, a series of exploration sequences (θ) (referred to as a minimum functional objective (MFO) staircase) by incrementally adding individual prospect and host tie-backs from the second ranked list of prospect and host projects tie-backs. At Step 1504, the method 1500 further comprises performing, with the physical computer processor, a probabilistic evaluation of the series of exploration sequences (θ) through Monte Carlo simulation using the integrated MDP model that accounts for chance of success for each prospect, ullage constraint of each host, ullage constraint of each node of the export network, and knock-on effects.

Step 1504 tries to build back the uncertainty and knock-on effect by incrementally including the individual projects in Table 4 in the exploration plan, as shown in Table 5. The incremental exploration plan in Table 5 is also referred to as the minimum functional objective (MFO) staircase, with the first row being the minimum functional case. The exploration plan will be evaluated probabilistically through Monte Carlo simulation honoring the chance of success for each prospect. In Monte Carlo simulation, multiple realizations are generated honoring the chance of success as shown in Table 1. All these realizations are evaluated and their results are averaged. The evaluation will also fully consider the host and export network nodes capacity and the knock-on effect resulting from it. The field management logic in the flow simulator mentioned herein may be utilized for this aspect.

TABLE 5
Constructing the MFO staircase.

| | EPVI | ENPV | | Incremental | Incremental |
|---|---|---|---|---|---|
| Exploration Plan | (—) | (—) | EDPI | ENPV (—) | EDPI |
| Prospect_22 - Host 11 | 0.386 | 0.488 | 2.27 | 0.488 | 2.27 |
| Case 1 + Prospect_14 - Host_6 | 0.456 | 0.522 | 2.15 | 0.0344 | 1.49 |
| Case 2 + Prospect_15 - Host_7 | 0.989 | 0.664 | 1.67 | 0.142 | 1.27 |
| Case 3 + Prospect_24 - Host_13 | 1.31 | 0.826 | 1.63 | 0.162 | 1.5 |
| Case 4 + Prospect_25 - Host_13 | 1.42 | 0.862 | 1.61 | 0.0361 | 1.34 |
| Case 5 + Prospect_5 - Host_2 | 2.44 | 1.44 | 1.59 | 0.579 | 1.57 |
| Case 6 + Prospect_16 - Host_8 | 2.87 | 1.7 | 1.59 | 0.259 | 1.6 |
| Case 7 + Prospect_26 - Host_13 | 3 | 1.74 | 1.58 | 0.0423 | 1.34 |
| Case 8 + Prospect_17 - Host_9 | 3.2 | 1.8 | 1.56 | 0.0573 | 1.29 |
| Case 9 + Prospect_7 - Host_3 | 3.55 | 1.81 | 1.51 | 0.0114 | 1.03 |
| Case 10 + Prospect_2 - Host_1 | 3.81 | 1.83 | 1.48 | 0.0192 | 1.08 |
| Case 11 + Prospect_27 - Host_13 | 3.9 | 1.83 | 1.47 | 0.000893 | 1.01 |
| Case 12 + Prospect_10 - Host_4 | 4.04 | 1.85 | 1.46 | 0.013 | 1.09 |
| Case 13 + Prospect_1 - Host_1 | 4.42 | 1.94 | 1.44 | 0.102 | 1.27 |

Iterative Refinement: Optional Step 1505 comprises iteratively refining, with the physical computer processor, the series of exploration sequences (θ) by removing at least one prospect and host tie-back responsive to screening criteria The Step 1505 also comprises performing, with the physical computer processor, a probabilistic evaluation of the refined series of exploration sequences (θ) through Monte Carlo simulation using the integrated MDP model that accounts for chance of success for each prospect, ullage constraint of each host, ullage constraint of each node of the export network, and knock-on effects. The goal of Step 1505 is to iteratively refine the exploration plan (e.g., from the Step 1504). Although this is not the case here in this synthetic example, it is possible that some of the projects in Table 5, which may be economical on their own, can result in negative incremental ENPV. This could be due to ullage being used by preceding projects. In this Step 1505, those projects can be eliminated, and Step 1504 can be repeated to evaluate the new incremental sequence. More stringent screening criteria can be applied depending on decision makers' preference, such as requiring the incremental EDPI to be larger than a certain fourth threshold. The screening criteria comprises a negative incremental ENPV, an incremental EDPI larger than a fourth threshold, or any combination thereof. The fourth threshold may be higher than 1 meaning that investment equals return, and therefore, the fourth threshold may be higher than 1. The fourth threshold is customizable and may be defined by a user. The fourth threshold may be dependent to one or more specific prospect and host tie-backs.

In the synthetic example problem in this study, none of the projects led to negative incremental ENPV, so Step 1505 did not change the result. FIG. 15B illustrates the synthetic example in the context of AHO.

At Step 1506, wherein the computer system comprises a display, and wherein the method 1500 further comprises: generating, with the physical computer processor, a representation of the series of exploration sequences (θ) using visual effects; and displaying the representation via the display. The series of exploration sequences (θ) generated by AHO (e.g., from the Step 1504 or Step 1505) may be displayed via the display at the Step 1506 in a diagram format, in a table format (e.g., such as Table 5 with a first column, an EPVI (−) column, an ENPV (−) column, an EDPI column, an Incremental ENPV (−) column, and/or an Incremental EDPI column similar to the Table 5), etc.

Comparison: FIG. 12 shows the comparison among the three approaches in terms of the objective function values. The darker grey dots show the evaluated plans from the BOO methods, with the darker grey line showing its final Pareto front. The lighter grey dots show the rank 1 and 2 Pareto front points from the PAO method, evaluated probabilistically, and the lighter grey line shows the Pareto front result from PAO. The black dots show the MFO staircase at the end of Step 1505 in the AHO workflow, with the black line indicating the Pareto front. Note that there is one point (1.59, 1.45) from the MFO staircase that is not exactly on the Pareto front. Generally, there is no guarantee that the MFO staircase constructed from Steps 1504 and 1505 will form a Pareto front. It can be seen that the BOO approach provides a Pareto front that improves upon the initial guess. The PAO approach provides a Pareto front with significantly higher NPVs. The AHO approach provides a superior Pareto front not only with improved ENPV and EDPI values, but the Pareto front is also more complete in that it covers a wide range of trade-offs between ENPV and EDPI. The numbers of function evaluations for the three methods are summarized in Table 6. The PAO only uses 34.5% as many runs as the BOO methods and the AHO method only uses 4.4% as many runs. The more the specificity and characteristics of the problem is exploited, the less runs the optimization needs to achieve good results.

TABLE 6
Function evaluation count for the three optimization strategies.

| Method Name | Forward Simulation Count |
|---|---|
| Black-box bi-objective Optimization | 30000 (100%) |
| Proxy-Accelerated Optimization | 10350 (34.5%) |
| Automated Hierarchical Optimization | 1313 (4.4%) |

The black-box method is theoretically sound and can explore the entire solution space to reach the global optimum if unlimited runs can be performed. However, in practical applications, the number of runs is often limited by the computational cost of the forward model. So black-box optimization can be terminated too early before it can meaningfully explore the solution space. The use of proxy enabled many more function evaluations and significantly improved the Pareto front. In addition, the efficiency of exploring the solution space relies on the parameterization scheme. With the parameterization defined in Eq. 3, the black-box methods tend to propose exploration plans that have a similar number of tie-back projects (solutions in FIG. 12 having similar slopes, indicating they have similar PVI) and fail to explore the lower right of the solution space where only a small number of project is conducted. There is room to improve the parameterization such that the exploration of the solution space is more efficient. The AHO approach, on the other hand, efficiently spreads out its Pareto front. This is by design in Step 1504, where the MFO staircase is constructed. In this case, the AHO approach provides a superior Pareto front than the two black-box methods with a substantially smaller number of runs. However, the AHO solution may not be truly optimal. For example, the heuristic host-prospect pairing may not be optimal, as it might tie multiple prospects to the same hosts without considering the need to spread the load in Step 1502. The treatment in Step 1505 to drop negative NPV project may also be suboptimal as those projects may be profitable if a different host is used. In general, if more function evaluations can be afforded, the black-box methods may yield better results. If only a limited number of function evaluations can be done, the AHO may be a more reliable choice.

More information may be available at He, Jincong, Yang, Changdong, Wang, Yanqing, Deng, Lichi, Nasir, Yusuf, Tran, Tom, Martin, Simon, and Kanwal Gupta. “Portfolio Optimization Under Uncertainty via Integrated Modeling with a Reservoir Simulator.” Paper presented at the SPE Reservoir Simulation Conference, Galveston, Texas, USA, Mar. 18, 2025, Paper Number: SPE-223856-MS, which is incorporated by reference herein.

Exploration portfolio management is crucial for oil companies operating deep-water assets, whose portfolios include hundreds of exploration prospects with varying risk profiles and hydrocarbon volumes and dozens of producing platforms with varying excess capacity available for new tie-back projects. In this document, we describe a methodology for portfolio planning and optimization (PPO) that uses reservoir simulators to model production of exploration scenarios, and the Markov decision process (MDP) to optimize the portfolio development plan. In the PPO methodology, prospects, existing platforms, and segments of the export pipeline network (that connect platforms to markets onshore) are modeled as wells and nodes in the reservoir simulator. As such, field management logic typically used for surface facilities is adapted to model the export network on a regional level. The exploration plan is modeled as an MDP to capture the impact of outcomes of earlier events on later decisions. Optimization is performed on a specially parameterized policy to allow for the optimization of exploration timing, tie-back options, and project sequences. The adapted simulation model is integrated with an external engine that evaluates the cost and economics of each scenario. The optimizer orchestrates the large number of runs needed for multi-objective optimization under uncertainty. This implementation is deployed to portfolio planners and applied to portfolios with more than 200 prospects and 70 platforms. Results showed that field management logic in the reservoir simulator is adequate to model all oil and gas capacity constraints in the platforms and export path on a regional level. Three optimization approaches were investigated with a synthetic portfolio example. It is shown that the black-box bi-objective optimization (BOO) can improve portfolio values, but the improvement is modest if the number of functions evaluated is small. Proxy accelerated optimization (PAO) allows for a larger population size and more iterations, producing solutions that are superior with similar computational costs. Finally, an automatic hierarchical optimization (AHO) approach is also examined, which leverages the structure of the problem to cut options step-by-step. AHO is shown to provide superior results to BOO and PAO in the example case but requires very problem-specific logic that may be hard to generalize. This document illustrates the adaptation of reservoir simulation for modeling productions from an exploration portfolio. The MDP formulation of the portfolio optimization problem and the policy-based parameterization are also illustrated herein. While the methodology is introduced with applications to the deep-water asset class, the modeling approach applies to generic portfolio problems in other asset classes and other parts of the world.

Conclusions: Provided herein are embodiments to model and optimize exploration portfolios, such as deep-water exploration portfolios. This approach specifically addresses the complex constraints and knock-on effects inherent in portfolio optimization problems through two aspects. The first aspect formulated the portfolio problem as an MDP, enabling systematic handling of sequential decision-making under uncertainty. The second aspect developed an integrated forward model combining production and economic simulations, where constrained production is efficiently managed through adapted reservoir simulation techniques.

As explained hereinabove, three distinct optimization approaches were investigated: black-box bi-objective optimization (BOO), proxy-accelerated optimization (PAO), and automated hierarchical optimization (AHO). The BOO method, while theoretically comprehensive, required significant computational resources and showed limited improvement in the Pareto front given practical computational constraints. The PAO approach substantially enhanced optimization efficiency through proxy modeling, enabling exploration of a broader solution space and achieving superior results with comparable computational costs. The AHO method proved particularly effective, combining computational efficiency with robust solution quality through its systematic reduction of problem complexity. This hierarchical approach demonstrated superior performance in identifying high quality solutions while requiring significantly fewer function evaluations than either BOO or PAO methods. The comparative analysis revealed that AHO's strategic decomposition of the problem space provides a practical balance between solution quality and computational efficiency, making it particularly suitable for large-scale exploration portfolio optimization.

This PPO methodology can be applied at multiple levels. At the consortium level, where a group of companies collaborates on capital-intensive projects, the PPO methodology can manage a large number of prospects and the associated production and transportation infrastructure, optimizing the overall economic return for all consortium members. At the individual operator level, the PPO methodology can be used to make informed decisions on capital and resource allocation, as well as to evaluate participation in farm-in or farm-out opportunities. By incorporating results from the economic engine, the PPO methodology allows for sensitivity analyses to account for the effects of commodity prices and the costs of labor and materials. Additionally, the PPO methodology is applicable in the inherent boom and bust cycles by effectively managing capital constraints.

Several promising directions for future research emerged from this work:
1. Investigation of advanced deep reinforcement learning algorithms, such as the proximal policy optimization, for solving the MDP problem. Such methods are powerful when combined with modern deep neural networks, although the solutions from them are usually non-analytical and can be hard to interpret and extract insights from.
2. Development of more efficient parameterization schemes for black-box methods (BOO and PAO) to enable more systematic exploration of the solution space, particularly focusing on strategies that can allow them to explore scenarios when fewer prospects are included in the plan (the high DPI, low NPV region). Initial guesses for the black-box methods can also be improved by heuristic prescreening such as those in the AHO method, or by design of experiments.
3. Refinement of the AHO methodology through, for example, more accurate ullage estimates in Step 2 by taking into account not only the host ullage projection but also the ullage projections along the flow path.
4. Extension of the PPO methodology to incorporate additional constraints and practical issues such as rig availability, the possibility for alternative flow paths for a host, and the possibility of building a standalone host instead of tying back to existing hosts.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Each of the following references is incorporated by reference herein:
Anagnostopoulos, Konstantinos P, & Mamanis, Georgios. 2011. Multiobjective evolutionary algorithms for complex portfolio optimization problems. Computational Management Science, 8, 259-279.
Bellman, Richard. 1957. Dynamic Programming. Princeton, NJ: Princeton University Press.
Chakrabarti, Subrata K. 2018. Risk assessment in deep water exploration and production projects. Journal of Offshore Mechanics and Arctic Engineering, 140(5).
Chen, Hao, Li, Xi-Yu, Lu, Xin-Ru, Sheng, Ni, Zhou, Wei, Geng, Hao-Peng, & Yu, Shiwei. 2021. A multi-objective optimization approach for the selection of overseas oil projects. Computers & Industrial Engineering, 151, 106977.
Deb, Kalyanmoy, Pratap, Amrit, Agarwal, Sameer, & Meyarivan, T. 2002. A fast and elitist multiobjective genetic algorithm: NSGA-II. IEEE Transactions on Evolutionary Computation, 6(2), 182-197.
Fortin, Felix-Antoine, De Rainville, Francois-Michel, Gardner, Marc-Andre, Parizeau, Marc, & Gagne, Christian. 2012. DEAP: Evolutionary Algorithms Made Easy. Journal of Machine Learning Research, 13 (jul), 2171-2175.
He, Jincong, Tang, Meng, Hu, Chaoshun, Tanaka, Shusei, Wang, Kainan, Wen, Xian-Huan, & Nasir, Yusuf. 2022. Deep reinforcement learning for generalizable field development optimization. SPE Journal, 27(01), 226-245.
Howard, Ronald A. 1960. Dynamic Programming and Markov Processes. Cambridge, MA: MIT Press.
Kaiser, Mark J, Snyder, Brian, & Pulsipher, Allan G. 2013. Offshore drilling industry and rig construction market in the Gulf of Mexico. Tech. rept. United States. Bureau of Ocean Energy Management. Gulf of Mexico OCS Region.
LaCosta, William C P, & Milkov, Alexei V. 2022. Petroleum exploration portfolios generated with different optimization approaches: Lessons for decision-makers. Journal of Petroleum Science and Engineering, 214, 110459.
Lee, John, & Smith, Robert. 2022. Infrastructure-led exploration: Maximizing subsea tieback opportunities in mature basins. Offshore Technology Conference, OTC-31890-MS.
Lessard, Rodney W. 2003. Portfolio optimization techniques for the energy industry. Pages SPE-82012 of: SPE Hydrocarbon Economics and Evaluation Symposium. SPE.
Mansini, Renata, Ogryczak, Wllodzimierz, & Speranza, M Grazia. 2003. LP solvable models for portfolio optimization: A classification and computational comparison. IMA Journal of Management Mathematics, 14(3), 187-220.
Metaxiotis, Konstantinos, & Liagkouras, Konstantinos. 2012. Multiobjective evolutionary algorithms for portfolio management: A comprehensive literature review. Expert systems with applications, 39(14), 11685-11698.
Murawski, Steven A, Hollander, David J, Gilbert, Sherryl, & Gracia, Adolfo. 2020. Deepwater oil and gas production in the Gulf of Mexico and related global trends. Scenarios and responses to future deep oil spills: Fighting the Next War, 16-32.
Nasir, Yusuf, He, Jincong, Hu, Chaoshun, Tanaka, Shusei, Wang, Kainan, & Wen, XianHuan. 2021. Deep reinforcement learning for constrained field development optimization in subsurface two-phase flow. Frontiers in Applied Mathematics and Statistics, 7, 689934.
Puterman, Martin L. 2014. Markov decision processes: discrete stochastic dynamic programming. John Wiley & Sons.
Quorum Software. 2024. Planning Space Economics. https://www.quorumsoftware.com/solutions/planning-economics-reserves/planning-space/economics/, Accessed: 2024 Dec. 17.
Rubinstein, Mark. 2002. Markowitz's “portfolio selection”: A fifty-year retrospective. The Journal of finance, 57(3), 1041-1045.
SLB. 2024a. FDPlan. https://www.slb.com/products-and-services/delivering-digital-at-scale/software/delfi/delfi-solutions/fdplan. Accessed: 2024 Dec. 17.
SLB. 2024b. INTERSECT High-Resolution Reservoir Simulator. https://www.slb.com/products-and-services/delivering-digital-at-scale/software/intersect-high-resolution-reservoir-simulator/intersect, Accessed: 2024 Dec. 17.
Willigers, Bart J A, Weis, Federico, & Majou, Felix. 2013. Creating portfolio insights by a practical multimethod optimization approach. SPE Economics & Management, 5(02), 47-56.
Yang, Changdong, He, Jincong, Onishi, Tsubasa, Du, Song, Wang, Zhenzhen, Guan, Xiaoyue, Chen, Jianping, & Wen, Xian-huan. 2022. A Physics-Based Proxy for Surface and Subsurface Coupled Simulation Models. SPE Journal, 27(04), 1962-1972.
U S Patent Application Publication No. 2023-0323772

Described herein are methods, systems, and non-transitory storage media (also referred to as electronic storage herein) that provide a manner of generating the integrated MDP model and usage of the integrated MDP model, such as via PAO and/or AHO. These embodiments are designed to be of particular use for portfolio planning and optimization, referred to as PPO.

Reference will now be made in detail to various embodiments, examples of which are illustrated in the accompanying drawings. In the detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

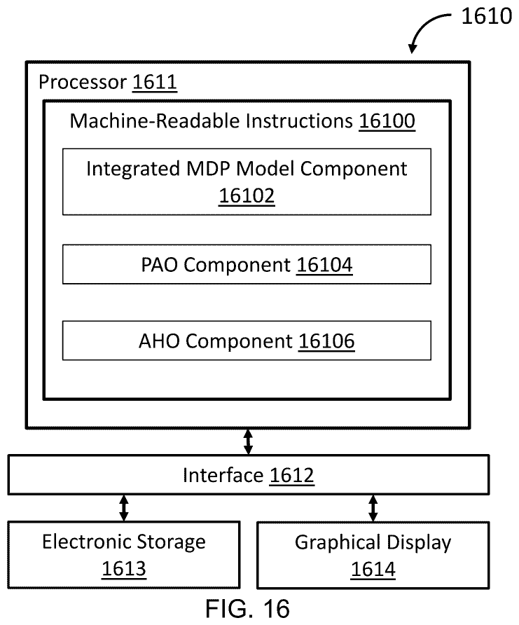

The methods and systems of the present disclosure may be implemented by a system and/or in a system, such as a system 1610 shown in FIG. 16. The system 1610 may include one or more of a processor 1611 (e.g., one or more of a physical processor), an interface 1612 (e.g., bus, wireless interface), an electronic storage 1613 (e.g., non-transitory storage media), a graphical display 1614, and/or other components. The processor 11 may be utilized for generating the integrated MDP model for evaluating objective functions for the export network using the export network data, the cost data, the economics data, and a reservoir simulator capable of handling constraints in a group. Generating the integrated MDP model comprises: a) defining each prospect as a well with a corresponding decline curve in the reservoir simulator, b) defining production for each host as a well with a corresponding decline curve in the reservoir simulator, c) defining each host as a group with a corresponding capacity in the reservoir simulator, and d) defining each node of the export network as a group with a corresponding capacity in the reservoir simulator. The processor 11 may utilize the generated integrated MDP model, such as via PAO and/or AHO.

The electronic storage 1613 may be configured to include any electronic storage medium that electronically stores information. The electronic storage 1613 may store software algorithms, information determined by the processor 1611, information received remotely, and/or other information that enables the system 1610 to function properly. For example, the electronic storage 1613 may store information relating to input such as export network data for the export network, cost data for the export network, economics data for the export network, and/or other information. For example, the electronic storage 1613 may store information relating to output such as an integrated MDP model and a representation of at least one exploration sequence for display, and/or other information. The electronic storage media of the electronic storage 1613 may be provided integrally (i.e., substantially non-removable) with one or more components of the system 1610 and/or as removable storage that is connectable to one or more components of the system 1610 via, for example, a port (e.g., a USB port, a Firewire port, etc.) or a drive (e.g., a disk drive, etc.). The electronic storage 1613 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 1613 may include one or more non-transitory computer readable storage medium storing one or more programs. The electronic storage 1613 may be a separate component within the system 10, or the electronic storage 1613 may be provided integrally with one or more other components of the system 1610 (e.g., the processor 1611). Although the electronic storage 1613 is shown in FIG. 16 as a single entity, this is for illustrative purposes only. In some implementations, the electronic storage 1613 may comprise a plurality of storage units. These storage units may be physically located within the same device, or the electronic storage 1613 may represent storage functionality of a plurality of devices operating in coordination.

The graphical display 1614 may refer to an electronic device that provides visual presentation of information. The graphical display 1614 may include a color display and/or a non-color display. The graphical display 1614 may be configured to visually present information. The graphical display 1614 may present information using/within one or more graphical user interfaces. For example, the graphical display 1614 may present information relating to an integrated MDP model and a representation of at least one exploration sequence for display, (intermediate & final results), and/or other information.

The processor 1611 may be configured to provide information processing capabilities in the system 1610. As such, the processor 1611 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 1611 may be configured to execute one or more machine-readable instructions 16100 to facilitate construction of the integrated MDP model and generation of the exploration plan, such as via PAO and/or AHO. The machine-readable instructions 16100 may include one or more computer program components. The machine-readable instructions 16100 may include an Integrated MDP Model component 16102, a PAO component 16104, an AHO component 16106, and/or other computer program components.

It should be appreciated that although computer program components are illustrated in FIG. 16 as being co-located within a single processing unit, one or more of computer program components may be located remotely from the other computer program components. While computer program components are described as performing or being configured to perform operations, computer program components may comprise instructions which may program processor 1611 and/or system 1610 to perform the operation.

While computer program components are described herein as being implemented via processor 1611 through machine-readable instructions 16100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 16100, the Integrated MDP Model component 16102 may be configured to perform the method 1300, including Step 1301.

The PAO component 16104 may be configured to perform the method 1400, including Steps 1401, 1402, 1403, and 1404.

The AHO component 16106 may be configured to perform the method 1500, including Steps 1501, 1502, 1503, 1504, 1505, and 1506.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 1611 may be configured to execute one or more additional computer program components that may perform some or all of the functionality attributed to one or more of computer program components described herein.

While particular embodiments are described above, it will be understood it is not intended to limit the invention to these particular embodiments. On the contrary, the invention includes alternatives, modifications, and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

TERMINOLOGY: The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

As used herein, the use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of +10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

As used herein, “obtaining” data or information may include one or more of accessing, acquiring, analyzing, determining, examining, identifying, loading, locating, opening, receiving, retrieving, reviewing, selecting, storing, and/or otherwise obtaining the data or information.

As used herein, the terms “host” and “platform” are used interchangeably herein.

As used herein, the term “capacity” of a host refers to how much capacity the host was designed to handle.

As used herein, the term “ullage” of a host refers to how much capacity is left in the host to handle new production.

As used herein, the term “knock-on effect” refers to a secondary or indirect consequence of an action, event, or decision.

As used herein, the term “tie-back” refers to connecting subsea well or field development (e.g., prospect) to an existing production facility (e.g., host or platform).

As used herein, it is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

Unless defined otherwise, all technical and scientific terms used herein have the same meanings as commonly understood by one of skill in the art to which the disclosed invention belongs. All citations referred herein are expressly incorporated by reference.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of generating an integrated Markov Decision Process (MDP) model, the computer-implemented method being implemented in a computer system that comprises a physical computer processor and a non-transitory storage medium, the computer-implemented method comprising:
obtaining, from the non-transitory storage medium, export network data for an export network, including obtaining data for a plurality of prospects of the export network, a plurality of nodes of the export network, a plurality of hosts of the export network, and production for each host of the export network;
obtaining, from the non-transitory storage medium, cost data for the export network;
obtaining, from the non-transitory storage medium, economics data for the export network; and
generating, with the physical computer processor, the integrated MDP model for evaluating objective functions for the export network using the export network data, the cost data, the economics data, and a reservoir simulator capable of handling constraints in a group, wherein generating the integrated MDP model comprises:
a) defining each prospect as a well with a corresponding decline curve in the reservoir simulator,
b) defining production for each host as a well with a corresponding decline curve in the reservoir simulator,
c) defining each host as a group with a corresponding capacity in the reservoir simulator, and
d) defining each node of the export network as a group with a corresponding capacity in the reservoir simulator.

2. The method of claim 1, wherein generating the integrated MDP model comprises using an exploration sequence defined by a list of 4-tuples:
$$θ = [ ( {p}_{1} , {h}_{1} , {u}_{1} , {s}_{1} ) , ( {p}_{2} , {h}_{2} , {u}_{2} , {s}_{2} ) , … ]$$
where θ represents an exploration sequence, pᵢ represents a prospect, hᵢ represents its designated host, uᵢ represents a required percentage ullage threshold for exploration initiation, and sᵢ is a flag indicating whether a tie-back should be skipped.

3. The method of claim 1, wherein the objective functions are given policy parameters and prospect outcomes: (ENPV, EDPI)=F(θ, φ), and wherein ENPV represents an expected net present value, EDPI represents an expected discounted profitability index, F represents the integrated MDP model, θ represents an exploration sequence, and φ represents uncertainty.

4. The method of claim 1, wherein the obtained export network data comprises an expected value production profile for each prospect, and wherein the method further comprises:
running, with the physical computer processor, a plurality of simulation scenarios using a deterministic evaluation to generate a net present value (NPV) and a discounted profitability index (DPI) for each prospect of each simulation scenario, wherein the deterministic evaluation considers only the expected value production profile for each prospect and assumes success for all prospects, and wherein each simulation scenario comprises an exploration sequence (θ), the expected value production profile for each prospect, and the integrated MDP model.

5. The method of claim 4, wherein the obtained export network data comprises a probabilistic distribution of a production profile for each prospect, and wherein the method further comprises:
extracting, with the physical computer processor, rank 1 and 2 Pareto front points from the plurality of simulation scenarios; and
re-evaluating, with the physical computer processor, a subset of simulation scenarios corresponding to the extracted rank 1 and 2 Pareto front points using a probabilistic evaluation to generate an ENPV and an EDPI of each simulation scenario of the subset of simulation scenarios, wherein each simulation scenario of the subset of simulation scenarios comprises the corresponding exploration sequence (θ), the probabilistic distribution of a production profile for each prospect, uncertainty, and the integrated MDP model.

6. The method of claim 5, wherein the computer system comprises a display, and wherein the method further comprises:
generating, with the physical computer processor, a representation of the generated ENPV and the generated EDPI for each simulation scenario of the subset of simulation scenarios, each representing the corresponding exploration sequence (θ), using visual effects: and
displaying the representation via the display.

7. The method of claim 6, further comprising:
generating, with the physical computer processor, a representation of a selected exploration sequence using visual effects; and
displaying the representation via the display.

8. The method of claim 1, wherein the obtained export network data comprises an expected value production profile for each prospect, and wherein the method further comprises:
running, with the physical computer processor, a first single unconstrained simulation scenario using an exploration sequence (θ), the expected value production profile for each prospect, and the integrated MDP model with a deterministic evaluation to generate a NPV and a DPI for each prospect, wherein the deterministic evaluation assumes unlimited ullage for each host, unlimited ullage for each node of the export network, success for all prospects, and each prospect ties back to a nearest host assuming unlimited ullage; and
wherein running the first single unconstrained simulation scenario generates a ranked list of prospects that ranks each prospect by its corresponding DPI, and
wherein running the first single unconstrained simulation scenario generates a ranked list of hosts that ranks each host by its corresponding ullage.

9. The method of claim 8, wherein generating the ranked list of prospects comprises removing any prospect having a corresponding NPV that is negative from the ranked list of prospects.

10. The method of claim 8, wherein generating the ranked list of prospects comprises:
comparing each DPI of a prospect to a first threshold; and
based on the comparison, removing any prospect with a corresponding DPI that does not satisfy the first threshold from the ranked list of prospects.

11. The method of claim 8, further comprising:
running, with the physical computer processor, a second single unconstrained simulation scenario using an exploration sequence (θ), the expected value production profile for each prospect, and the integrated MDP model with a deterministic evaluation to generate a NPV and a DPI for each prospect, wherein the deterministic evaluation assumes unlimited ullage for each host, unlimited ullage for each node of the export network, success for all prospects, and each prospect ties back to a nearest host with sufficient ullage based on a second threshold; and
wherein running the second single unconstrained simulation scenario generates a first ranked list of prospect and host tie-backs that is ranked by corresponding DPI.

12. The method of claim 11, further comprising:
running, with the physical computer processor, a constrained simulation scenario for each prospect and host tie-back from the ranked list of prospect and host tie-backs using an exploration sequence (θ) that includes only that prospect and host tie-back, the expected value production profile of that prospect, and the integrated MDP model with a deterministic evaluation to generate a NPV and a DPI for that prospect and host tie-back,
wherein running the constrained simulation scenario for each prospect and host tie-back generates a second ranked list of prospect and host tie-backs that is ranked by corresponding DPI.

13. The method of claim 12, further comprising:
generating, with the physical computer processor, a series of exploration sequences (θ) by incrementally adding individual prospect and host tie-backs from the second ranked list of prospect and host projects tie-backs.

14. The method of claim 13, further comprising:
performing, with the physical computer processor, a probabilistic evaluation of the series of exploration sequences (θ) through Monte Carlo simulation using the integrated MDP model that accounts for chance of success for each prospect, ullage constraint of each host, ullage constraint of each node of the export network, and knock-on effects.

15. The method of claim 14, further comprising:
iteratively refining, with the physical computer processor, the series of exploration sequences (θ) by removing at least one prospect and host tie-back responsive to screening criteria; and
performing, with the physical computer processor, a probabilistic evaluation of the refined series of exploration sequences (θ) through Monte Carlo simulation using the integrated MDP model that accounts for chance of success for each prospect, ullage constraint of each host, ullage constraint of each node of the export network, and knock-on effects.

16. The method of claim 14, wherein the computer system comprises a display, and wherein the method further comprises:
generating, with the physical computer processor, a representation of the series of exploration sequences (θ) using visual effects; and
displaying the representation via the display.

17. A computer system, comprising:
a non-transitory storage medium; and
a physical computer processor configured by machine-readable instructions to perform a computer-implemented method of generating an integrated Markov Decision Process (MDP) model, the method comprising:
obtaining, from the non-transitory storage medium, export network data for an export network, including obtaining data for a plurality of prospects of the export network, a plurality of nodes of the export network, a plurality of hosts of the export network, and production for each host of the export network;
obtaining, from the non-transitory storage medium, cost data for the export network;
obtaining, from the non-transitory storage medium, economics data for the export network; and
generating, with the physical computer processor, the integrated MDP model for evaluating objective functions for the export network using the export network data, the cost data, the economics data, and a reservoir simulator capable of handling constraints in a group, wherein generating the integrated MDP model comprises:
a) defining each prospect as a well with a corresponding decline curve in the reservoir simulator,
b) defining production for each host as a well with a corresponding decline curve in the reservoir simulator,
c) defining each host as a group with a corresponding capacity in the reservoir simulator, and
d) defining each node of the export network as a group with a corresponding capacity in the reservoir simulator.

18. The system of claim 17, wherein the obtained export network data comprises an expected value production profile for each prospect, and wherein the physical computer processor is further configured by machine readable instructions to:
run, with the physical computer processor, a first single unconstrained simulation scenario using an exploration sequence (θ), the expected value production profile for each prospect, and the integrated MDP model with a deterministic evaluation to generate a NPV and a DPI for each prospect, wherein the deterministic evaluation assumes unlimited ullage for each host, unlimited ullage for each node of the export network, success for all prospects, and each prospect ties back to a nearest host assuming unlimited ullage; and
wherein running the first single unconstrained simulation scenario generates a ranked list of prospects that ranks each prospect by its corresponding DPI, and
wherein running the first single unconstrained simulation scenario generates a ranked list of hosts that ranks each host by its corresponding ullage.

19. The system of claim 18, and wherein the physical computer processor is further configured by machine readable instructions to:
run, with the physical computer processor, a second single unconstrained simulation scenario using an exploration sequence (θ), the expected value production profile for each prospect, and the integrated MDP model with a deterministic evaluation to generate a NPV and a DPI for each prospect, wherein the deterministic evaluation assumes unlimited ullage for each host, unlimited ullage for each node of the export network, success for all prospects, and each prospect ties back to a nearest host with sufficient ullage based on a second threshold; and
wherein running the second single unconstrained simulation scenario generates a first ranked list of prospect and host tie-backs that is ranked by corresponding DPI.

20. The system of claim 19, and wherein the physical computer processor is further configured by machine readable instructions to:
run, with the physical computer processor, a constrained simulation scenario for each prospect and host tie-back from the ranked list of prospect and host tie-backs using an exploration sequence (θ) that includes only that prospect and host tie-back, the expected value production profile of that prospect, and the integrated MDP model with a deterministic evaluation to generate a NPV and a DPI for that prospect and host tie-back,
wherein running the constrained simulation scenario for each prospect and host tie-back generates a second ranked list of prospect and host tie-backs that is ranked by corresponding DPI.

21. The system of claim 20, and wherein the physical computer processor is further configured by machine readable instructions to:
generate, with the physical computer processor, a series of exploration sequences (θ) by incrementally adding individual prospect and host tie-backs from the second ranked list of prospect and host projects tie-backs.

22. The system of claim 21, and wherein the physical computer processor is further configured by machine readable instructions to:
perform, with the physical computer processor, a probabilistic evaluation of the series of exploration sequences (θ) through Monte Carlo simulation using the integrated MDP model that accounts for chance of success for each prospect, ullage constraint of each host, ullage constraint of each node of the export network, and knock-on effects.

23. The system of claim 22, and wherein the physical computer processor is further configured by machine readable instructions to:
iteratively refine, with the physical computer processor, the series of exploration sequences (θ) by removing at least one prospect and host tie-back responsive to screening criteria; and
perform, with the physical computer processor, a probabilistic evaluation of the refined series of exploration sequences (θ) through Monte Carlo simulation using the integrated MDP model that accounts for chance of success for each prospect, ullage constraint of each host, ullage constraint of each node of the export network, and knock-on effects.
